(19) United States
(12) Patent Application Publication
(10) Pub. No.: US 2026/0172938 A1
(43) Pub. Date: Jun. 18, 2026

(54) SPECTRUM AGGREGATION FOR ROBUST CONNECTIVITY

(71) Applicant: Nokia Technologies Oy, Espoo (FI)

(72) Inventors: Janne Veikko KAASALAINEN, Söderkulla (FI); Charles NADER, Tullinge (SE); Gayatri Virupaxayya EMMIMATH, Bangalore (IN)

(21) Appl. No.: 19/417,603

(22) Filed: Dec. 12, 2025

Related U.S. Application Data
(60) Provisional application No. 63/733,648, filed on Dec. 13, 2024.

(51) Int. Cl. H04W 36/30

(52) U.S. Cl. CPC H04W 36/305

(57) ABSTRACT

In some example embodiments, there may be provided a method, comprising transmitting, based at least in part on detection that a Radio Link Failure (RLF) of a radio link associated with at least one first cell about to occur, an activation request to at least one second cell which is inactive, wherein the activation request includes spectrum aggregation activation for at least one spectrum resource, and switching, based at least in part on an indication from a network node, to a radio link associated at least one inactive second cell.

### FIELD

Various example embodiments relate to the field of wireless communication and, in particular to spectrum aggregation for robust connectivity.

### BACKGROUND

Cellular communication systems may be built on top of one or more protocols that control how data and/or information is exchanged, e.g. between a user and a network. These protocols may be divided into User Plane (UP) sections and Control Plane (CP) sections. The UP may be dedicated to the actual task of transmitting the data/information between user and network while the CP may be dedicated to ensuring that the UP is/maintains operational. The CP may be used for establishing the UP. The CP may also ensure, in particular uninterrupted, functioning of the UP. It may be preferred to provide and/or ensure a robust connection and/or connectivity for spectrum resources even in cases of cell failure(s), for example Packet Data Unit (PDU) session and/or Quality of Service (QoS) flow or slice, etc.

### SUMMARY

According to some aspects, there is provided the subject matter of the independent claims. Some further aspects, advantages and/or features are defined in the dependent claims, the description and/or the accompanying drawings.

In a first example, there may be provided an apparatus, comprising:
at least one processor; and
at least one memory storing instructions that, when executed by the at least one processor, cause the apparatus at least to perform:
requesting, based at least in part on detection that a Radio Link Failure (RLF) of a radio link associated with at least one first cell is about to occur, activation of at least one spectrum resource that is associated with at least one second cell configured for spectrum aggregation using at least one backup configuration of the at least one first cell, and
switching, based at least in part on an indication from a network node, to a radio link associated with the at least one second cell.

In an example embodiment, there is provided an apparatus, in particular according to the first example, wherein the indication indicates that the at least one second cell has been configured to take over for the at least one first cell.

In an example embodiment, there is provided an apparatus, in particular according to the first example and/or any one of the associated example embodiments described herein, wherein the at least one backup configuration of the at least one first cell is available before detection that the RLF of the radio link associated with the at least one first cell is about to occur.

In an example embodiment, there is provided an apparatus, in particular according to the first example and/or any one of the associated example embodiments described herein, wherein the at least one backup configuration of the at least one first cell is pre-stored in the apparatus.

In an example embodiment, there is provided an apparatus, in particular according to the first example and/or any one of the associated example embodiments described herein, wherein the at least one processor and the at least one memory storing instructions that, when executed by the at least one processor, cause the apparatus at least to perform:
determining the at least one backup configuration of the at least one first cell, based on a Radio Resource Reconfiguration (RRC) message received from the network node.

In an example embodiment, which may be referred to as a first example embodiment of the first example, there is provided an apparatus, in particular according to the first example and/or any one of the associated example embodiments described herein, wherein the at least one processor and the at least one memory storing instructions that, when executed by the at least one processor, cause the apparatus at least to perform:
detecting that the RLF of the radio link associated with the at least one first cell is about to occur.

In an example embodiment, there is provided an apparatus, in particular according to the first example embodiment of the first example described herein, wherein detecting that the RLF of the radio link associated with the at least one first cell is about to occur initiates requesting activation of the at least one spectrum resource configured for spectrum aggregation.

In an example embodiment, there is provided an apparatus, in particular according to the first example and/or any one of the associated example embodiments described herein, wherein the at least one processor and the at least one memory storing instructions that, when executed by the at least one processor, cause the apparatus at least to perform:
determining to skip a Radio Resource Control (RRC) re-establishment procedure based at least in part on the indication from the network node.

In an example embodiment, which may be referred to as a second example embodiment of the first example, there is provided an apparatus, in particular according to the first example and/or any one of the associated example embodiments described herein, wherein the at least one processor and the at least one memory storing instructions that, when executed by the at least one processor, cause the apparatus at least to perform:
determining, based at least in part on a further indication from the at least one first cell, that the at least one spectrum resource is designated for spectrum aggregation.

In an example embodiment, there is provided an apparatus, in particular according to the second example embodiment of the first example described herein, wherein the further indication is received before detecting that the RLF of the radio link associated with the at least one first cell is about to occur.

In an example embodiment, which may be referred to as a third example embodiment of the first example, there is provided an apparatus, in particular according to the first example and/or any one of the associated example embodiments described herein, wherein the at least one backup configuration of the at least one first cell includes at least one Radio Resource Control (RRC) parameter to modify the at least one second cell to take over for the at least one first cell.

In an example embodiment, there is provided an apparatus, in particular according to the third example embodiment of the first example described herein, wherein the at least one RRC parameter includes at least one of:
an additional Physical Uplink Control Channel (PUCCH) resource,
   a rule when to activate the at least one second cell,
   a resource for cell activation including at least one of: a cell activation preamble, Random Access Channel (RACH), or Uplink (UL) Grant, or
   a carrier preference for the at least one second cell.

In an example embodiment, there is provided an apparatus, in particular according to the first example and/or any one of the associated example embodiments described herein, wherein the at least one processor and the at least one memory storing instructions that, when executed by the at least one processor, cause the apparatus at least to perform:
transmitting data via the radio link associated with the at least one second cell using the at least one spectrum resource.

In an example embodiment, there is provided an apparatus, in particular according to the first example and/or any one of the associated example embodiments described herein, wherein the at least one processor and the at least one memory storing instructions that, when executed by the at least one processor, cause the apparatus at least to perform:
modifying the at least one backup configuration based on a message from the network node after switching to the radio link associated with the at least one second cell.

In an example embodiment, there is provided an apparatus, in particular according to the first example and/or any one of the associated example embodiments described herein, wherein switching to the radio link associated with the at least one second cell occurs without data flow interruption.

In an example embodiment, there is provided an apparatus, in particular according to the first example and/or any one of the associated example embodiments described herein, wherein spectrum aggregation includes Carrier Aggregation (CA), wherein the at least one spectrum resource is at least one carrier, wherein the at least one first cell is configured for control plane functions, wherein the at least one first cell is a Primary Cell (PCell) and the at least one second cell is a Secondary Cell (SCell).

In an example embodiment, there is provided an apparatus, in particular according to the first example and/or any one of the associated example embodiments described herein, wherein the apparatus is a User equipment (UE) or wherein the apparatus is comprised in a UE.

Furthermore, in particular further according to the first example, there may be provided an apparatus, comprising means for:
requesting, based at least in part on detection that a Radio Link Failure (RLF) of a radio link associated with at least one first cell is about to occur, activation of at least one spectrum resource that is associated with at least one second cell configured for spectrum aggregation using at least one backup configuration of the at least one first cell, and
switching, based at least in part on an indication from a network node, to a radio link associated with the at least one second cell.

In an example embodiment, there is provided an apparatus, in particular according to the first example, wherein the indication indicates that the at least one second cell has been configured to take over for the at least one first cell.

In an example embodiment, there is provided an apparatus, in particular according to the first example and/or any one of the associated example embodiments described herein, wherein the at least one backup configuration of the at least one first cell is available before detection that the RLF of the radio link associated with the at least one first cell is about to occur.

In an example embodiment, there is provided an apparatus, in particular according to the first example and/or any one of the associated example embodiments described herein, wherein the at least one backup configuration of the at least one first cell is pre-stored in the apparatus.

In an example embodiment, there is provided an apparatus, in particular according to the first example and/or any one of the associated example embodiments described herein, wherein the means are further configured for:
determining the at least one backup configuration of the at least one first cell, based on a Radio Resource Reconfiguration (RRC) message received from the network node.

In an example embodiment, which may be referred to as a first example embodiment of the first example, there is provided an apparatus, in particular according to the first example and/or any one of the associated example embodiments described herein, wherein the means are further configured for:
detecting that the RLF of the radio link associated with the at least one first cell is about to occur.

In an example embodiment, there is provided an apparatus, in particular according to the first example embodiment of the first example described herein, wherein detecting that the RLF of the radio link associated with the at least one first cell is about to occur initiates requesting activation of the at least one spectrum resource configured for spectrum aggregation.

In an example embodiment, there is provided an apparatus, in particular according to the first example and/or any one of the associated example embodiments described herein, wherein the means are further configured for:
determining to skip a Radio Resource Control (RRC) re-establishment procedure based at least in part on the indication from the network node.

In an example embodiment, which may be referred to as a second example embodiment of the first example, there is provided an apparatus, in particular according to the first example and/or any one of the associated example embodiments described herein, wherein the means are further configured for:
determining, based at least in part on a further indication from the at least one first cell, that the at least one spectrum resource is designated for spectrum aggregation.

In an example embodiment, there is provided an apparatus, in particular according to the second example embodiment of the first example described herein, wherein the further indication is received before detecting that the RLF of the radio link associated with the at least one first cell is about to occur.

In an example embodiment, which may be referred to as a third example embodiment of the first example, there is provided an apparatus, in particular according to the first example and/or any one of the associated example embodiments described herein, wherein the at least one backup configuration of the at least one first cell includes at least one Radio Resource Control (RRC) parameter to modify the at least one second cell to take over for the at least one first cell.

In an example embodiment, there is provided an apparatus, in particular according to the third example embodiment of the first example described herein, wherein the at least one RRC parameter includes at least one of:
an additional Physical Uplink Control Channel (PUCCH) resource,
a rule when to activate the at least one second cell,
   a resource for cell activation including at least one of: a cell activation preamble, Random Access Channel (RACH), or Uplink (UL) Grant, or
   a carrier preference for the at least one second cell.

In an example embodiment, there is provided an apparatus, in particular according to the first example and/or any one of the associated example embodiments described herein, wherein the means are further configured for:
transmitting data via the radio link associated with the at least one second cell using the at least one spectrum resource.

In an example embodiment, there is provided an apparatus, in particular according to the first example and/or any one of the associated example embodiments described herein, wherein the means are further configured for:
modifying the at least one backup configuration based on a message from the network node after switching to the radio link associated with the at least one second cell.

In an example embodiment, there is provided an apparatus, in particular according to the first example and/or any one of the associated example embodiments described herein, wherein switching to the radio link associated with the at least one second cell occurs without data flow interruption.

In an example embodiment, there is provided an apparatus, in particular according to the first example and/or any one of the associated example embodiments described herein, wherein spectrum aggregation includes Carrier Aggregation (CA), wherein the at least one spectrum resource is at least one carrier, wherein the at least one first cell is configured for control plane functions, wherein the at least one first cell is a Primary Cell (PCell) and the at least one second cell is a Secondary Cell (SCell).

In an example embodiment, there is provided an apparatus, in particular according to the first example and/or any one of the associated example embodiments described herein, wherein the apparatus is a User equipment (UE) or wherein the apparatus is comprised in a UE.

In a second example, there may be provided a method, comprising:
requesting, based at least in part on detection that a Radio Link Failure (RLF) of a radio link associated with at least one first cell is about to occur, activation of at least one spectrum resource that is associated with at least one second cell configured for spectrum aggregation using at least one backup configuration of the at least one first cell, and
switching, based at least in part on an indication from a network node, to a radio link associated with the at least one second cell.

In an example embodiment, there is provided a method, in particular according to the second example, wherein the indication indicates that the at least one second cell has been configured to take over for the at least one first cell.

In an example embodiment, there is provided a method, in particular according to the second example and/or any one of the associated example embodiments described herein, wherein the at least one backup configuration of the at least one first cell is available before detection that the RLF of the radio link associated with the at least one first cell is about to occur.

In an example embodiment, there is provided a method, in particular according to the second example and/or any one of the associated example embodiments described herein, wherein the at least one backup configuration of the at least one first cell is pre-stored in the apparatus.

In an example embodiment, there is provided a method, in particular according to the second example and/or any one of the associated example embodiments described herein, wherein the method comprises:
determining the at least one backup configuration of the at least one first cell, based on a Radio Resource Reconfiguration (RRC) message received from the network node.

In an example embodiment, which may be referred to as a first example embodiment of the second example, there is provided a method, in particular according to the second example and/or any one of the associated example embodiments described herein, the method comprises:
detecting that the RLF of the radio link associated with the at least one first cell is about to occur.

In an example embodiment, there is provided a method, in particular according to the first example embodiment of the second example described herein, wherein detecting that the RLF of the radio link associated with the at least one first cell is about to occur initiates requesting activation of the at least one spectrum resource configured for spectrum aggregation.

In an example embodiment, there is provided a method, in particular according to the second example and/or any one of the associated example embodiments described herein, the method comprises:
determining to skip a Radio Resource Control (RRC) re-establishment procedure based at least in part on the indication from the network node.

In an example embodiment, which may be referred to as a second example embodiment of the second example, there is provided a method, in particular according to the second example and/or any one of the associated example embodiments described herein, the method comprises:
determining, based at least in part on a further indication from the at least one first cell, that the at least one spectrum resource is designated for spectrum aggregation.

In an example embodiment, there is provided a method, in particular according to the second example embodiment of the second example described herein, wherein the further indication is received before detecting that the RLF of the radio link associated with the at least one first cell is about to occur.

In an example embodiment, which may be referred to as a third example embodiment of the second example, there is provided a method, in particular according to the second example and/or any one of the associated example embodiments described herein, wherein the at least one backup configuration of the at least one first cell includes at least one Radio Resource Control (RRC) parameter to modify the at least one second cell to take over for the at least one first cell.

In an example embodiment, there is provided a method, in particular according to the third example embodiment of the second example described herein, wherein the at least one RRC parameter includes at least one of:
an additional Physical Uplink Control Channel (PUCCH) resource,
a rule when to activate the at least one second cell,
a resource for cell activation including at least one of: a cell activation preamble, Random Access Channel (RACH), or Uplink (UL) Grant, or
a carrier preference for the at least one second cell.

In an example embodiment, there is provided a method, in particular according to the second example and/or any one of the associated example embodiments described herein, the method comprises:
transmitting data via the radio link associated with the at least one second cell using the at least one spectrum resource.

In an example embodiment, there is provided a method, in particular according to the second example and/or any one of the associated example embodiments described herein, the method comprises:
modifying the at least one backup configuration based on a message from the network node after switching to the radio link associated with the at least one second cell.

In an example embodiment, there is provided a method, in particular according to the second example and/or any one of the associated example embodiments described herein, wherein switching to the radio link associated with the at least one second cell occurs without data flow interruption.

In an example embodiment, there is provided a method, in particular according to the second example and/or any one of the associated example embodiments described herein, wherein spectrum aggregation includes Carrier Aggregation (CA), wherein the at least one spectrum resource is at least one carrier, wherein the at least one first cell is configured for control plane functions, wherein the at least one first cell is a Primary Cell (PCell) and the at least one second cell is a Secondary Cell (SCell).

In a third example, there may be provided a non-transitory computer readable storage medium comprising program instructions that, when executed by an apparatus, in particular according to the first example and/or any one of the associated example embodiments described herein, causes operations comprising:
requesting, based at least in part on detection that a Radio Link Failure (RLF) of a radio link associated with at least one first cell is about to occur, activation of at least one spectrum resource that is associated with at least one second cell configured for spectrum aggregation using at least one backup configuration of the at least one first cell, and
switching, based at least in part on an indication from a network node, to a radio link associated with the at least one second cell.

The third example may further comprise one or more steps and/or features of the method and/or any one of the associated example embodiments recited in the second example.

In a fourth example, there may be provided an apparatus, comprising:
at least one processor; and
at least one memory storing instructions that, when executed by the at least one processor, cause the apparatus at least to perform:
transmitting, based at least in part on detection that a Radio Link Failure (RLF) of a radio link associated with at least one first cell is about to occur, an activation request to at least one second cell which is active, wherein the activation request includes spectrum aggregation activation for at least one spectrum resource, and
switching, based at least in part on an indication from a network node, to a radio link associated with the at least one active second cell.

In an example embodiment, which may be referred to as a first example embodiment of the fourth example, there is provided an apparatus, in particular according to the fourth example, wherein the indication indicates activation of the at least one spectrum resource configured for spectrum aggregation.

In an example embodiment, there is provided an apparatus, in particular according to the fourth example and/or any one of the associated example embodiments described herein, wherein the at least one spectrum resource is an inactive spectrum resource of a Protocol Data Unit (PDU) session.

In an example embodiment, there is provided an apparatus, in particular according to the fourth example and/or the first example embodiment of the fourth example, wherein the at least one spectrum resource is an active spectrum resource.

In an example embodiment, there is provided an apparatus, in particular according to the fourth example and/or any one of the associated example embodiments described herein, wherein the at least one spectrum resource is a backup spectrum resource included in at least one backup configuration of the at least one first cell, wherein the at least one spectrum resource is designated for spectrum aggregation.

In an example embodiment, there is provided an apparatus, in particular according to the fourth example and/or any one of the associated example embodiments described herein, wherein the activation request is transmitted via Uplink Control Information (UCI) to the at least one active second cell.

In an example embodiment, which may be referred to as a second example embodiment of the fourth example, there is provided an apparatus, in particular according to the fourth example and/or any one of the associated example embodiments described herein, wherein the at least one processor and the at least one memory storing instructions that, when executed by the at least one processor, cause the apparatus at least to perform:

assigning at least one broadcasting resource to the at least one active second cell using at least one backup configuration of the at least one first cell.

In an example embodiment, which may be referred to as a second example embodiment of the fourth example, there is provided an apparatus, in particular according to the second example embodiment of the fourth example, wherein the at least one broadcasting resource carriers Uplink Control Information (UCI).

In an example embodiment, there is provided an apparatus, in particular according to the first example embodiment of the fourth example and/or the second example embodiment of the fourth example, wherein the at least one broadcasting resource is a Physical Uplink Control Channel (PUCCH) or a Physical Uplink Shared Channel (PUSCH).

In an example embodiment, there is provided an apparatus, in particular according to the fourth example and/or any one of the associated example embodiments described herein, wherein the at least one backup configuration of the at least one first cell includes data indicative of when inactive spectrum resources are activatable.

In an example embodiment, there is provided an apparatus, in particular according to the fourth example and/or any one of the associated example embodiments described herein, wherein the at least one processor and the at least one memory storing instructions that, when executed by the at least one processor, cause the apparatus at least to perform:
determining, based at least in part on the indication from the network node, that spectrum aggregation activation was successful.

In an example embodiment, there is provided an apparatus, in particular according to the fourth example and/or any one of the associated example embodiments described herein, wherein the at least one processor and the at least one memory storing instructions that, when executed by the at least one processor, cause the apparatus at least to perform:
determining, based at least in part on the indication from the network node, that the at least one active second cell has been configured to take over for the at least one first cell.

In an example embodiment, there is provided an apparatus, in particular according to the fourth example and/or any one of the associated example embodiments described herein, wherein the at least one processor and the at least one memory storing instructions that, when executed by the at least one processor, cause the apparatus at least to perform:
transmitting data to the at least one active second cell using the at least one spectrum resource after switching to the radio link associated with the at least one active second cell.

In an example embodiment, there is provided an apparatus, in particular according to the fourth example and/or any one of the associated example embodiments described herein, wherein the at least one processor and the at least one memory storing instructions that, when executed by the at least one processor, cause the apparatus at least to perform:
modifying the at least one backup configuration based on a message from the network node after switching to the radio link associated with the at least one active second cell.

In an example embodiment which may be referred to as a third example embodiment of the fourth example, there is provided an apparatus, in particular according to the fourth example and/or any one of the associated example embodiments described herein, wherein detecting that the RLF of the radio link associated with the at least one first cell is about to occur initiates transmitting the activation request.

In an example embodiment which may be referred to as a fourth example embodiment of the fourth example, there is provided an apparatus, in particular according to the fourth example and/or any one of the associated example embodiments described herein, wherein the at least one processor and the at least one memory storing instructions that, when executed by the at least one processor, cause the apparatus at least to perform:
determining to skip a Radio Resource Control (RRC) re-establishment procedure based at least in part on the indication from the network node.

In an example embodiment which may be referred to as a fifth example embodiment of the fourth example, there is provided an apparatus, in particular according to the fourth example and/or any one of the associated example embodiments described herein, wherein the at least one backup configuration of the at least one first cell is available before detection that the RLF of the radio link to the at least one first cell is about to occur.

In an example embodiment, there is provided an apparatus, in particular according to any one of the third example embodiment of the fourth example, the fourth example embodiment of the fourth example and/or the fifth example embodiment of the fourth example, wherein the message from the node of the network is a Radio Resource Control (RRC) Reconfiguration message.

In an example embodiment, there is provided an apparatus, in particular according to the fourth example and/or any one of the associated example embodiments described herein, wherein switching to the radio link associated with the at least one active second cell occurs without data flow interruption.

In an example embodiment, there is provided an apparatus, in particular according to the fourth example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one active second cell is a Secondary Cell (SCell).

In an example embodiment, there is provided an apparatus, in particular according to the fourth example and/or any one of the associated example embodiments described herein, wherein the apparatus is a User equipment (UE) or wherein the apparatus is comprised in a UE.

Furthermore, in particular further according to the fourth example, there may be provided an apparatus, comprising means for:
transmitting, based at least in part on detection that a Radio Link Failure (RLF) of a radio link associated with at least one first cell is about to occur, an activation request to at least one second cell which is active, wherein the activation request includes spectrum aggregation activation for at least one spectrum resource, and
switching, based at least in part on an indication from a network node, to a radio link associated with the at least one active second cell.

In an example embodiment, which may be referred to as a first example embodiment of the fourth example, there is provided an apparatus, in particular according to the fourth example, wherein the indication indicates activation of the at least one spectrum resource configured for spectrum aggregation.

In an example embodiment, there is provided an apparatus, in particular according to the fourth example and/or any one of the associated example embodiments described herein, wherein the at least one spectrum resource is an inactive spectrum resource of a Protocol Data Unit (PDU) session.

In an example embodiment, there is provided an apparatus, in particular according to the fourth example and/or the first example embodiment of the fourth example, wherein the at least one spectrum resource is an active spectrum resource.

In an example embodiment, there is provided an apparatus, in particular according to the fourth example and/or any one of the associated example embodiments described herein, wherein the at least one spectrum resource is a backup spectrum resource included in at least one backup configuration of the at least one first cell, wherein the at least one spectrum resource is designated for spectrum aggregation.

In an example embodiment, there is provided an apparatus, in particular according to the fourth example and/or any one of the associated example embodiments described herein, wherein the activation request is transmitted via Uplink Control Information (UCI) to the at least one active second cell.

In an example embodiment, which may be referred to as a second example embodiment of the fourth example, there is provided an apparatus, in particular according to the fourth example and/or any one of the associated example embodiments described herein, wherein the means are further configured for:
assigning at least one broadcasting resource to the at least one active second cell using at least one backup configuration of the at least one first cell.

In an example embodiment, which may be referred to as a second example embodiment of the fourth example, there is provided an apparatus, in particular according to the second example embodiment of the fourth example, wherein the at least one broadcasting resource carriers Uplink Control Information (UCI).

In an example embodiment, there is provided an apparatus, in particular according to the first example embodiment of the fourth example and/or the second example embodiment of the fourth example, wherein the at least one broadcasting resource is a Physical Uplink Control Channel (PUCCH) or a Physical Uplink Shared Channel (PUSCH).

In an example embodiment, there is provided an apparatus, in particular according to the fourth example and/or any one of the associated example embodiments described herein, wherein the at least one backup configuration of the at least one first cell includes data indicative of when inactive spectrum resources are activatable.

In an example embodiment, there is provided an apparatus, in particular according to the fourth example and/or any one of the associated example embodiments described herein, wherein the means are further configured for:
determining, based at least in part on the indication from the network node, that spectrum aggregation activation was successful.

In an example embodiment, there is provided an apparatus, in particular according to the fourth example and/or any one of the associated example embodiments described herein, wherein the means are further configured for:
determining, based at least in part on the indication from the network node, that the at least one active second cell has been configured to take over for the at least one first cell.

In an example embodiment, there is provided an apparatus, in particular according to the fourth example and/or any one of the associated example embodiments described herein, wherein the means are further configured for:
transmitting data to the at least one active second cell using the at least one spectrum resource after switching to the radio link associated with the at least one active second cell.

In an example embodiment, there is provided an apparatus, in particular according to the fourth example and/or any one of the associated example embodiments described herein, wherein the means are further configured for:
modifying the at least one backup configuration based on a message from the network node after switching to the radio link associated with the at least one active second cell.

In an example embodiment which may be referred to as a third example embodiment of the fourth example, there is provided an apparatus, in particular according to the fourth example and/or any one of the associated example embodiments described herein, wherein detecting that the RLF of the radio link associated with the at least one first cell is about to occur initiates transmitting the activation request.

In an example embodiment which may be referred to as a fourth example embodiment of the fourth example, there is provided an apparatus, in particular according to the fourth example and/or any one of the associated example embodiments described herein, wherein the means are further configured for:
determining to skip a Radio Resource Control (RRC) re-establishment procedure based at least in part on the indication from the network node.

In an example embodiment which may be referred to as a fifth example embodiment of the fourth example, there is provided an apparatus, in particular according to the fourth example and/or any one of the associated example embodiments described herein, wherein the at least one backup configuration of the at least one first cell is available before detection that the RLF of the radio link to the at least one first cell is about to occur.

In an example embodiment, there is provided an apparatus, in particular according to any one of the third example embodiment of the fourth example, the fourth example embodiment of the fourth example and/or the fifth example embodiment of the fourth example, wherein the message from the node of the network is a Radio Resource Control (RRC) Reconfiguration message.

In an example embodiment, there is provided an apparatus, in particular according to the fourth example and/or any one of the associated example embodiments described herein, wherein switching to the radio link associated with the at least one active second cell occurs without data flow interruption.

In an example embodiment, there is provided an apparatus, in particular according to the fourth example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one active second cell is a Secondary Cell (SCell).

In an example embodiment, there is provided an apparatus, in particular according to the fourth example and/or any one of the associated example embodiments described herein, wherein the apparatus is a User equipment (UE) or wherein the apparatus is comprised in a UE.

In a fifth example, there may be provided a method, comprising:
transmitting, based at least in part on detection that a Radio Link Failure (RLF) of a radio link associated with at least one first cell is about to occur, an activation request to at least one second cell which is active, wherein the activation request includes spectrum aggregation activation for at least one spectrum resource, and
switching, based at least in part on an indication from a network node, to a radio link associated with the at least one active second cell.

In an example embodiment, which may be referred to as a first example embodiment of the fifth example, there is provided a method, in particular according to the fifth example, wherein the indication indicates activation of the at least one spectrum resource configured for spectrum aggregation.

In an example embodiment, there is provided a method, in particular according to the fifth example and/or any one of the associated example embodiments described herein, wherein the at least one spectrum resource is an inactive spectrum resource of a Protocol Data Unit (PDU) session.

In an example embodiment, there is provided a method, in particular according to the fifth example and/or the first example embodiment of the fifth example, wherein the at least one spectrum resource is an active spectrum resource.

In an example embodiment, there is provided a method, in particular according to the fifth example and/or any one of the associated example embodiments described herein, wherein the at least one spectrum resource is a backup spectrum resource included in at least one backup configuration of the at least one first cell, wherein the at least one spectrum resource is designated for spectrum aggregation.

In an example embodiment, there is provided a method, in particular according to the fifth example and/or any one of the associated example embodiments described herein, wherein the activation request is transmitted via Uplink Control Information (UCI) to the at least one active second cell.

In an example embodiment, which may be referred to as a second example embodiment of the fifth example, there is provided a method, in particular according to the fifth example and/or any one of the associated example embodiments described herein, wherein the method comprises:
assigning at least one broadcasting resource to the at least one active second cell using at least one backup configuration of the at least one first cell.

In an example embodiment, which may be referred to as a second example embodiment of the fifth example, there is provided a method, in particular according to the second example embodiment of the fifth example, wherein the at least one broadcasting resource carriers Uplink Control Information (UCI).

In an example embodiment, there is provided a method, in particular according to the first example embodiment of the fifth example and/or the second example embodiment of the fifth example, wherein the at least one broadcasting resource is a Physical Uplink Control Channel (PUCCH) or a Physical Uplink Shared Channel (PUSCH).

In an example embodiment, there is provided a method, in particular according to the fifth example and/or any one of the associated example embodiments described herein, wherein the at least one backup configuration of the at least one first cell includes data indicative of when inactive spectrum resources are activatable.

In an example embodiment, there is provided a method, in particular according to the fifth example and/or any one of the associated example embodiments described herein, wherein the method comprises:
determining, based at least in part on the indication from the network node, that spectrum aggregation activation was successful.

In an example embodiment, there is provided a method, in particular according to the fifth example and/or any one of the associated example embodiments described herein, wherein the method comprises:
determining, based at least in part on the indication from the network node, that the at least one active second cell has been configured to take over for the at least one first cell.

In an example embodiment, there is provided a method, in particular according to the fifth example and/or any one of the associated example embodiments described herein, wherein the method comprises:
transmitting data to the at least one active second cell using the at least one spectrum resource after switching to the radio link associated with the at least one active second cell.

In an example embodiment, there is provided a method, in particular according to the fifth example and/or any one of the associated example embodiments described herein, wherein the method comprises:
modifying the at least one backup configuration based on a message from the network node after switching to the radio link associated with the at least one active second cell.

In an example embodiment which may be referred to as a third example embodiment of the fifth example, there is provided a method, in particular according to the fifth example and/or any one of the associated example embodiments described herein, wherein detecting that the RLF of the radio link associated with the at least one first cell is about to occur initiates transmitting the activation request.

In an example embodiment which may be referred to as a fourth example embodiment of the fifth example, there is provided a method, in particular according to the fifth example and/or any one of the associated example embodiments described herein, wherein the method comprises:
determining to skip a Radio Resource Control (RRC) re-establishment procedure based at least in part on the indication from the network node.

In an example embodiment which may be referred to as a fifth example embodiment of the fifth example, there is provided a method, in particular according to the fifth example and/or any one of the associated example embodiments described herein, wherein the at least one backup configuration of the at least one first cell is available before detection that the RLF of the radio link to the at least one first cell is about to occur.

In an example embodiment, there is provided a method, in particular according to any one of the third example embodiment of the fifth example, the fourth example embodiment of the fifth example and/or the fifth example embodiment of the fifth example, wherein the message from the node of the network is a Radio Resource Control (RRC) Reconfiguration message.

In an example embodiment, there is provided a method, in particular according to the fifth example and/or any one of the associated example embodiments described herein, wherein switching to the radio link associated with the at least one active second cell occurs without data flow interruption.

In an example embodiment, there is provided a method, in particular according to the fifth example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one active second cell is a Secondary Cell (SCell).

In a sixth example, there may be provided a non-transitory computer readable storage medium comprising program instructions that, when executed by an apparatus, in particular according to the fourth example and/or any one of the associated example embodiments described herein, causes operations comprising:
transmitting, based at least in part on detection that a Radio Link Failure (RLF) of a radio link associated with at least one first cell is about to occur, an activation request to at least one second cell which is active, wherein the activation request includes spectrum aggregation activation for at least one spectrum resource, and
switching, based at least in part on an indication from a network node, to a radio link associated with the at least one active second cell.

The sixth example may further comprise one or more steps and/or features of the method and/or any one of the associated example embodiments recited in the fifth example.

In a seventh example, there may be provided an apparatus, comprising:
at least one processor; and
at least one memory storing instructions that, when executed by the at least one processor, cause the apparatus at least to perform:
transmitting, based at least in part on detection that a Radio Link Failure (RLF) of a radio link associated with at least one first cell about to occur, an activation request to at least one second cell which is inactive, wherein the activation request includes spectrum aggregation activation for at least one spectrum resource, and
switching, based at least in part on an indication from a network node, to a radio link associated at least one inactive second cell.

In an example embodiment, which may be referred to as a first example embodiment of the seventh example, there is provided an apparatus, in particular according to the seventh example, wherein the activation request is transmitted using at least one backup configuration of the at least one first cell.

In an example embodiment, which may be referred to as a second example embodiment of the seventh example, there is provided an apparatus, in particular according to the first example embodiment of the seventh example, wherein the at least one backup configuration includes at least one broadcasting resource for cell activation.

In an example embodiment, which may be referred to as a third example embodiment of the seventh example, there is provided an apparatus, in particular according to any one of the first example embodiment of the seventh example and/or the second example embodiment of the seventh example, wherein the activation request is transmitted to the at least one inactive second cell using at least one broadcasting resource for cell activation included in the at least one backup configuration.

In an example embodiment, which may be referred to as a fourth example embodiment of the seventh example, there is provided an apparatus, in particular according to any one of the second example embodiment of the seventh example and/or the third example embodiment of the seventh example, wherein the at least one processor and the at least one memory storing instructions that, when executed by the at least one processor, cause the apparatus at least to perform:
assigning at least one broadcasting resource for cell activation to the at least one inactive second cell using the at least one backup configuration of the at least one first cell

In an example embodiment, there is provided an apparatus, in particular according to any one of the second example embodiment of the seventh example, the third example embodiment of the seventh example and/or the third example embodiment of the seventh example, wherein the at least one broadcasting resource for cell activation includes at least one of:
a cell activation preamble,
a Random Access Channel (RACH), or
an Uplink (UL) grant.

In an example embodiment, which may be referred to as a fifth example embodiment of the seventh example, there is provided an apparatus, in particular according to any one of the second example embodiment of the seventh example, the third example embodiment of the seventh example and/or the fourth example embodiment of the seventh example, wherein the at least one broadcasting resource carriers Uplink Control Information (UCI).

In an example embodiment, there is provided an apparatus, in particular according to any one of the second example embodiment of the seventh example, the third example embodiment of the seventh example and/or the fourth example embodiment of the seventh example or the fifth example embodiment of the seventh example, wherein the at least one broadcasting resource is a Physical Uplink Control Channel (PUCCH) or a Physical Uplink Shared Channel (PUSCH).

In an example embodiment, there is provided an apparatus, in particular according to the seventh example and/or any one of the associated example embodiments described herein, wherein the at least one processor and the at least one memory storing instructions that, when executed by the at least one processor, cause the apparatus at least to perform:
determining that no spectrum resources are available to transmit the activation request to the at least one inactive second cell.

In an example embodiment, there is provided an apparatus, in particular according to the seventh example and/or any one of the associated example embodiments described herein, wherein the at least one processor and the at least one memory storing instructions that, when executed by the at least one processor, cause the apparatus at least to perform:
determining, based on the indication from the network node, that spectrum aggregation was successful.

In an example embodiment, there is provided an apparatus, in particular according to the seventh example and/or any one of the associated example embodiments described herein, wherein the at least one processor and the at least one memory storing instructions that, when executed by the at least one processor, cause the apparatus at least to perform:
determining, based on the indication from the network node, that that the at least one inactive second cell has been configured to take over for the at least one first cell.

In an example embodiment, there is provided an apparatus, in particular according to the seventh example and/or any one of the associated example embodiments described herein, wherein the indication is received via at least one of:
a lower layer signal, or
a Wake Up Signal (WUS)-type of signal.

In an example embodiment, there is provided an apparatus, in particular according to the seventh example and/or any one of the associated example embodiments described herein, wherein the at least one processor and the at least one memory storing instructions that, when executed by the at least one processor, cause the apparatus at least to perform:
modifying the at least one backup configuration based on a message from the network node after switching to the radio link of the at least one inactive second cell.

In an example embodiment, there is provided an apparatus, in particular according to the seventh example and/or any one of the associated example embodiments described herein, wherein detecting that the RLF of the radio link associated with the at least one first cell is about to occur initiates transmitting the activation request.

In an example embodiment, there is provided an apparatus, in particular according to the seventh example and/or any one of the associated example embodiments described herein, wherein the at least one processor and the at least one memory storing instructions that, when executed by the at least one processor, cause the apparatus at least to perform:
determining to skip a Radio Resource Control (RRC) re-establishment procedure based at least in part on the indication from the network node.

In an example embodiment, there is provided an apparatus, in particular according to the seventh example and/or any one of the associated example embodiments described herein, wherein the at least one backup configuration of the at least one first cell is available before detection that the RFL of the radio link to the at least one first cell is about to occur.

In an example embodiment, there is provided an apparatus, in particular according to the seventh example and/or any one of the associated example embodiments described herein, wherein the message from the network node is a Radio Resource Control (RRC) Reconfiguration message.

In an example embodiment, there is provided an apparatus, in particular according to the seventh example and/or any one of the associated example embodiments described herein, wherein switching to the radio link associated with the at least one inactive second cell occurs without data flow interruption.

In an example embodiment, there is provided an apparatus, in particular according to the seventh example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one second cell is a Secondary Cell (SCell).

In an example embodiment, there is provided an apparatus, in particular according to the seventh example and/or any one of the associated example embodiments described herein, wherein the apparatus is a User equipment (UE) or wherein the apparatus is comprised in a UE.

Furthermore, in particular further according to the seventh example, there may be provided an apparatus, comprising means for:
transmitting, based at least in part on detection that a Radio Link Failure (RLF) of a radio link associated with at least one first cell about to occur, an activation request to at least one second cell which is inactive, wherein the activation request includes spectrum aggregation activation for at least one spectrum resource, and
switching, based at least in part on an indication from a network node, to a radio link associated at least one inactive second cell.

In an example embodiment, which may be referred to as a first example embodiment of the seventh example, there is provided an apparatus, in particular according to the seventh example, wherein the activation request is transmitted using at least one backup configuration of the at least one first cell.

In an example embodiment, which may be referred to as a second example embodiment of the seventh example, there is provided an apparatus, in particular according to the first example embodiment of the seventh example, wherein the at least one backup configuration includes at least one broadcasting resource for cell activation.

In an example embodiment, which may be referred to as a third example embodiment of the seventh example, there is provided an apparatus, in particular according to any one of the first example embodiment of the seventh example and/or the second example embodiment of the seventh example, wherein the activation request is transmitted to the at least one inactive second cell using at least one broadcasting resource for cell activation included in the at least one backup configuration.

In an example embodiment, which may be referred to as a fourth example embodiment of the seventh example, there is provided an apparatus, in particular according to any one of the second example embodiment of the seventh example and/or the third example embodiment of the seventh example, wherein the at least one processor and the at least one memory storing instructions that, when executed by the at least one processor, cause the apparatus at least to perform:
assigning at least one broadcasting resource for cell activation to the at least one inactive second cell using the at least one backup configuration of the at least one first cell

In an example embodiment, there is provided an apparatus, in particular according to any one of the second example embodiment of the seventh example, the third example embodiment of the seventh example and/or the third example embodiment of the seventh example, wherein the at least one broadcasting resource for cell activation includes at least one of:
a cell activation preamble,
a Random Access Channel (RACH), or
an Uplink (UL) grant.

In an example embodiment, which may be referred to as a fifth example embodiment of the seventh example, there is provided an apparatus, in particular according to any one of the second example embodiment of the seventh example, the third example embodiment of the seventh example and/or the fourth example embodiment of the seventh example, wherein the at least one broadcasting resource carriers Uplink Control Information (UCI).

In an example embodiment, there is provided an apparatus, in particular according to any one of the second example embodiment of the seventh example, the third example embodiment of the seventh example and/or the fourth example embodiment of the seventh example or the fifth example embodiment of the seventh example, wherein the at least one broadcasting resource is a Physical Uplink Control Channel (PUCCH) or a Physical Uplink Shared Channel (PUSCH).

In an example embodiment, there is provided an apparatus, in particular according to the seventh example and/or any one of the associated example embodiments described herein, wherein the means are further configured for:
determining that no spectrum resources are available to transmit the activation request to the at least one inactive second cell.

In an example embodiment, there is provided an apparatus, in particular according to the seventh example and/or any one of the associated example embodiments described herein, wherein the means are further configured for:
determining, based on the indication from the network node, that spectrum aggregation was successful.

In an example embodiment, there is provided an apparatus, in particular according to the seventh example and/or any one of the associated example embodiments described herein, wherein the means are further configured for:
determining, based on the indication from the network node, that that the at least one inactive second cell has been configured to take over for the at least one first cell.

In an example embodiment, there is provided an apparatus, in particular according to the seventh example and/or any one of the associated example embodiments described herein, wherein the indication is received via at least one of:
a lower layer signal, or
a Wake Up Signal (WUS)-type of signal.

In an example embodiment, there is provided an apparatus, in particular according to the seventh example and/or any one of the associated example embodiments described herein, wherein the means are further configured for:
modifying the at least one backup configuration based on a message from the network node after switching to the radio link of the at least one inactive second cell.

In an example embodiment, there is provided an apparatus, in particular according to the seventh example and/or any one of the associated example embodiments described herein, wherein detecting that the RLF of the radio link associated with the at least one first cell is about to occur initiates transmitting the activation request.

In an example embodiment, there is provided an apparatus, in particular according to the seventh example and/or any one of the associated example embodiments described herein, wherein the means are further configured for:
determining to skip a Radio Resource Control (RRC) re-establishment procedure based at least in part on the indication from the network node.

In an example embodiment, there is provided an apparatus, in particular according to the seventh example and/or any one of the associated example embodiments described herein, wherein the at least one backup configuration of the at least one first cell is available before detection that the RFL of the radio link to the at least one first cell is about to occur.

In an example embodiment, there is provided an apparatus, in particular according to the seventh example and/or any one of the associated example embodiments described herein, wherein the message from the network node is a Radio Resource Control (RRC) Reconfiguration message.

In an example embodiment, there is provided an apparatus, in particular according to the seventh example and/or any one of the associated example embodiments described herein, wherein switching to the radio link associated with the at least one inactive second cell occurs without data flow interruption.

In an example embodiment, there is provided an apparatus, in particular according to the seventh example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one second cell is a Secondary Cell (SCell).

In an example embodiment, there is provided an apparatus, in particular according to the seventh example and/or any one of the associated example embodiments described herein, wherein the apparatus is a User equipment (UE) or wherein the apparatus is comprised in a UE.

In an eighth example, there may be provided a method, comprising:
transmitting, based at least in part on detection that a Radio Link Failure (RLF) of a radio link associated with at least one first cell about to occur, an activation request to at least one second cell which is inactive, wherein the activation request includes spectrum aggregation activation for at least one spectrum resource, and
switching, based at least in part on an indication from a network node, to a radio link associated at least one inactive second cell.

In an example embodiment, which may be referred to as a first example embodiment of the eighth example, there is provided a method, in particular according to the eighth example, wherein the activation request is transmitted using at least one backup configuration of the at least one first cell.

In an example embodiment, which may be referred to as a second example embodiment of the eighth example, there is provided a method, in particular according to the first example embodiment of the eighth example, wherein the at least one backup configuration includes at least one broadcasting resource for cell activation.

In an example embodiment, which may be referred to as a third example embodiment of the eighth example, there is provided a method, in particular according to any one of the first example embodiment of the eighth example and/or the second example embodiment of the eighth example, wherein the activation request is transmitted to the at least one inactive second cell using at least one broadcasting resource for cell activation included in the at least one backup configuration.

In an example embodiment, which may be referred to as a fourth example embodiment of the eighth example, there is provided a method, in particular according to any one of the second example embodiment of the eighth example and/or the third example embodiment of the eighth example, wherein the method comprises:
assigning at least one broadcasting resource for cell activation to the at least one inactive second cell using the at least one backup configuration of the at least one first cell

In an example embodiment, there is provided a method, in particular according to any one of the second example embodiment of the eighth example, the third example embodiment of the eighth example and/or the third example embodiment of the eighth example, wherein the at least one broadcasting resource for cell activation includes at least one of:
a cell activation preamble,
a Random Access Channel (RACH), or
an Uplink (UL) grant.

In an example embodiment, which may be referred to as a fifth example embodiment of the eighth example, there is provided a method, in particular according to any one of the second example embodiment of the eighth example, the third example embodiment of the eighth example and/or the fourth example embodiment of the eighth example, wherein the at least one broadcasting resource carriers Uplink Control Information (UCI).

In an example embodiment, there is provided a method, in particular according to any one of the second example embodiment of the eighth example, the third example embodiment of the eighth example and/or the fourth example embodiment of the eighth example or the fifth example embodiment of the eighth example, wherein the at least one broadcasting resource is a Physical Uplink Control Channel (PUCCH) or a Physical Uplink Shared Channel (PUSCH).

In an example embodiment, there is provided a method, in particular according to the eighth example and/or any one of the associated example embodiments described herein, wherein the method comprises:
determining that no spectrum resources are available to transmit the activation request to the at least one inactive second cell.

In an example embodiment, there is provided a method, in particular according to the eighth example and/or any one of the associated example embodiments described herein, wherein the method comprises:
determining, based on the indication from the network node, that spectrum aggregation was successful.

In an example embodiment, there is provided a method, in particular according to the eighth example and/or any one of the associated example embodiments described herein, wherein the method comprises:
determining, based on the indication from the network node, that that the at least one inactive second cell has been configured to take over for the at least one first cell.

In an example embodiment, there is provided a method, in particular according to the eighth example and/or any one of the associated example embodiments described herein, wherein the indication is received via at least one of:
a lower layer signal, or
a Wake Up Signal (WUS)-type of signal.

In an example embodiment, there is provided a method, in particular according to the eighth example and/or any one of the associated example embodiments described herein, wherein the method comprises:
modifying the at least one backup configuration based on a message from the network node after switching to the radio link of the at least one inactive second cell.

In an example embodiment, there is provided a method, in particular according to the eighth example and/or any one of the associated example embodiments described herein, wherein detecting that the RLF of the radio link associated with the at least one first cell is about to occur initiates transmitting the activation request.

In an example embodiment, there is provided a method, in particular according to the eighth example and/or any one of the associated example embodiments described herein, wherein the method comprises:
determining to skip a Radio Resource Control (RRC) re-establishment procedure based at least in part on the indication from the network node.

In an example embodiment, there is provided a method, in particular according to the eighth example and/or any one of the associated example embodiments described herein, wherein the at least one backup configuration of the at least one first cell is available before detection that the RFL of the radio link to the at least one first cell is about to occur.

In an example embodiment, there is provided a method, in particular according to the eighth example and/or any one of the associated example embodiments described herein, wherein the message from the network node is a Radio Resource Control (RRC) Reconfiguration message.

In an example embodiment, there is provided a method, in particular according to the eighth example and/or any one of the associated example embodiments described herein, wherein switching to the radio link associated with the at least one inactive second cell occurs without data flow interruption.

In an example embodiment, there is provided a method, in particular according to the eighth example and/or any one of the associated example embodiments described herein, wherein spectrum aggregation includes Carrier Aggregation (CA), wherein the at least on spectrum resource is at least one carrier, wherein the at least one first cell is configured for control plane functions, wherein the at least one first cell is a Primary Cell (PCell) and the at least one second cell is a Secondary Cell (SCell).

In a ninth example, there may be provided a non-transitory computer readable storage medium comprising program instructions that, when executed by an apparatus, in particular according to the seventh example and/or any one of the associated example embodiments described herein, causes operations comprising:
transmitting, based at least in part on detection that a Radio Link Failure (RLF) of a radio link associated with at least one first cell about to occur, an activation request to at least one second cell which is inactive, wherein the activation request includes spectrum aggregation activation for at least one spectrum resource, and
switching, based at least in part on an indication from a network node, to a radio link associated at least one inactive second cell.

The ninth example may further comprise one or more steps and/or features of the method and/or any one of the associated example embodiments recited in the eighth example.

In tenth example, which may be combined with any one of the examples and/or associated example embodiments described herein, there may be provided an apparatus, in particular a network node, comprising: at least one processor; and at least one memory storing instructions that, when executed by the at least one processor, cause the apparatus at least to perform:
activating, based at least in part on detection that a Radio Link Failure (RLF) of a radio link associated with at least one first cell is about to occur, at least one spectrum resource that is associated with at least one second cell configured for spectrum aggregation,
transmitting an indication that indicates activation of the at least one spectrum resource that is associated with at least one second cell configured for spectrum aggregation.

In an example embodiment, there is provided an apparatus, in particular according to the tenth example, wherein the indication indicates that a radio link associated with the at least one second cell is available for radio link switching.

In an example embodiment, there is provided an apparatus, in particular according to the tenth example, wherein the indication indicates that spectrum aggregation activation was successful.

In an example embodiment, there is provided an apparatus, in particular according to the tenth example and/or any one of the associated example embodiments described herein, wherein the indication indicates that the at least one second cell has been configured to take over for the at least one first cell.

In an example embodiment, there is provided an apparatus, in particular according to the tenth example and/or any one of the associated example embodiments described herein, wherein the indication is transmitted via at least one of:
a lower layer signal, or
a Wake Up Signal (WUS)-type of signal, or
at least one spectrum resource that is already active.

In an example embodiment, which may be referred to as a first example embodiment of the tenth example, there is provided an apparatus, in particular according to the tenth example and/or any one of the associated example embodiments described herein, wherein the at least one processor and the at least one memory storing instructions that, when executed by the at least one processor, cause the apparatus at least to perform:
transmitting at least one backup configuration of the at least one first cell before detection that the RLF of the radio link associated with the at least one first cell is about to occur.

In an example embodiment, there is provided an apparatus, in particular according to the first example embodiment of the tenth example, wherein the at least one backup configuration is transmitted using a Radio Resource Reconfiguration (RRC) message.

In an example embodiment, which may be referred to as a second example embodiment of the tenth example, there is provided an apparatus, in particular according to the tenth example and/or any one of the associated example embodiments described herein, wherein the at least one processor and the at least one memory storing instructions that, when executed by the at least one processor, cause the apparatus at least to perform:
detecting that the RLF of the radio link associated with the at least one first cell is about to occur.

In an example embodiment, there is provided an apparatus, in particular according to the second example embodiment of the tenth example, wherein detecting that the RLF of the radio link associated with the at least one first cell is about to occur initiates transmission of the indication.

In an example embodiment, which may be referred to as a third example embodiment of the tenth example, there is provided an apparatus, in particular according to the tenth example and/or any one of the associated example embodiments described herein, wherein the at least one processor and the at least one memory storing instructions that, when executed by the at least one processor, cause the apparatus at least to perform:
transmitting at least one further indication that indicates that the at least one spectrum resource is designated for spectrum aggregation.

In an example embodiment, there is provided an apparatus, in particular according to the third example embodiment of the tenth example, wherein the further indication is received before detecting that the RLF of the radio link associated with the at least one first cell is about to occur.

In an example embodiment, there is provided an apparatus, in particular according to the tenth example and/or any one of the associated example embodiments described herein, wherein the at least one processor and the at least one memory storing instructions that, when executed by the at least one processor, cause the apparatus at least to perform:
receiving data via the radio link associated with the at least one second cell using the at least one spectrum resource.

In an example embodiment, there is provided an apparatus, in particular according to the tenth example and/or any one of the associated example embodiments described herein, wherein the at least one processor and the at least one memory storing instructions that, when executed by the at least one processor, cause the apparatus at least to perform:
transmitting a further message to initiate modification of the at the at least one backup configuration.

In an example embodiment, there is provided an apparatus, in particular according to the tenth example and/or any one of the associated example embodiments described herein, wherein the at least one second cell is active before detecting that the RLF of the radio link associated with the at least one first cell is about to occur.

In an example embodiment, there is provided an apparatus, in particular according to the tenth example and/or any one of the associated example embodiments described herein, wherein the at least one spectrum resource is an inactive spectrum resource.

In an example embodiment, which may be referred to as a fourth example embodiment of the tenth example, there is provided an apparatus, in particular according to the tenth example and/or any one of the associated example embodiments described herein, wherein the at least one second cell is inactive before detecting that the RLF of the radio link associated with the at least one first cell is about to occur.

In an example embodiment, which may be referred to as a fifth example embodiment of the tenth example, there is provided an apparatus, in particular according to the fourth example embodiment of the tenth example, wherein the at least one processor and the at least one memory storing instructions that, when executed by the at least one processor, cause the apparatus at least to perform:
activating, based at least in part on detection that a RLF of a radio link associated with at least one first cell is about to occur, the at least one second inactive cell.

In an example embodiment, which may be referred to as a sixth example embodiment of the tenth example, there is provided an apparatus, in particular according to the tenth example and/or any one of the associated example embodiments described herein, wherein the at least one processor and the at least one memory storing instructions that, when executed by the at least one processor, cause the apparatus at least to perform:
deactivating the at least one first cell.

In an example embodiment, there is provided an apparatus, in particular according to the fifth example embodiment of the tenth example described herein, wherein the at least one first cell is deactivated based on activation of the at least one second inactive cell.

In an example embodiment, which may be referred to as a seventh example embodiment of the tenth example, there is provided an apparatus, in particular according to any one of the fifth example embodiment of the tenth example and/or the sixth example embodiment of the tenth example, wherein the at least one processor and the at least one memory storing instructions that, when executed by the at least one processor, cause the apparatus at least to perform:
maintaining a configuration associated with the at least one first cell, in particular based on deactivation of the at least one first cell.

In an example embodiment, there is provided an apparatus, in particular according to the seventh example embodiment of the tenth example, wherein the at least one processor and the at least one memory storing instructions that, when executed by the at least one processor, cause the apparatus at least to perform:
restoring the at least one first cell using on the maintained configuration associated with the at least one first cell, based on detection that the radio link associated with the at least one first cell has recovered.

In an example embodiment, there is provided an apparatus, in particular according to the tenth example and/or any one of the associated example embodiments described herein, wherein the apparatus is a network node or wherein the apparatus is comprised in a network node.

It should be noted that the features and/or the steps described with respect to the tenth example may be defined correspondingly in yet further examples such as a method and/or a non-transitory computer readable medium. For example, when a feature recites that an element “is received/transmitted by/to a certain entity” it may be defined as a method step such as “receiving/transmitting . . . , by/to the certain entity”. One or more steps, features and/or characteristics of the other examples and/or associated example embodiments described herein may be combined with the tenth example, e.g. by defining the steps from the perspective of the network node instead of the apparatus, e.g. the UE. Likewise, one or more steps, features and/or characteristics of the other examples and/or associated example embodiments described herein may be changed/formulated from the perspective of the network node instead of the apparatus, e.g. the UE. For example, when a feature/step recites “receiving/transmitting by/to”, e.g. the UE, it may be defined in/combined with the tenth example and/or associated example embodiments as a corresponding feature/step reciting “transmitting/receiving to/by” the network node respectively. The same may be achieved without combination with the tenth example, e.g. so that the steps, features and/or characteristics of the other examples and/or associated example embodiments described herein may be simply formulated from the perspective of the network node instead of the apparatus, e.g. the UE.

### BRIEF DESCRIPTION OF THE DRAWINGS

Some example embodiments will now be described with reference to the accompanying drawings.

A full and enabling disclosure to one of ordinary skill in the art is set forth more particularly in the remainder of the specification including reference to the accompanying drawings wherein:

FIG. 1 shows an example signaling chart according to subject-matter described herein;

FIG. 2 shows an example signaling chart according to subject-matter described herein;

FIG. 3 shows an example signaling chart according to subject-matter described herein;

FIG. 4 shows an example signaling chart according to subject-matter described herein;

FIG. 5 shows a flow chart of an example of the subject-matter described herein;

FIG. 6 shows a flow chart of an example of the subject-matter described herein;

FIG. 7 shows a flow chart of an example of the subject-matter described herein, and

FIG. 8 shows an apparatus as described herein.

### DETAILED DESCRIPTION

Reference will now be made in detail to the various embodiments, one or more examples of which are illustrated in the figures. Within the following description of the drawings, the same reference numbers may refer to same components. Generally, only the differences with respect to individual embodiments may be described. Each example may be provided by way of explanation and is not meant as a limitation. Further, features illustrated or described as part of one embodiment can be used on or in conjunction with other embodiments to yield yet a further embodiment. It is intended that the description includes such modifications and variations.

The drawings are schematic drawings which are not drawn to scale. Some elements in the drawings may have dimensions which are exaggerated for the purpose of highlighting aspects of the present disclosure and/or for the sake of clarity of presentation.

Cellular communication systems may be built on top of one or more protocols that control how data and/or information is exchanged, e.g. between a user and a network. These protocols may be divided into User Plane (UP) sections and Control Plane (CP) sections. The UP may be dedicated to the actual task of transmitting the data/information between user and network while the CP may be dedicated to ensuring that the UP is/maintains operational. The CP may be used for establishing the UP. The CP may also ensure, in particular uninterrupted, functioning of the UP. It may be preferred to provide and/or ensure a robust connection and/or connectivity for spectrum resources even in cases of cell failure(s).

An example protocol that may be used for CP is Radio Resource Control (RRC) or a RRC protocol. The same may, for example, define mechanisms for setting up the connection, establishing the other (e.g. UP) protocol layers and/or changing or reconfiguring their parameter(s), as well as various procedures intended to keep UP and/or CP operations. The RRC protocol can also provide RRC configuration options.

A “Radio Link Failure” (RLF) may refer to a condition, a state and/or a status of a link, e.g. a communication link or a radio link, between two parties, e.g. two apparatuses such as for example a User Equipment (UE) and a network node, wherein the link becomes unstable, volatile, instable, fragile, deteriorates e.g. becomes poor(er), e.g. in terms of quality, and/or the link fails or is about to fail. It may also refer to a situation in which the connection provided by the link cannot be maintained, e.g. partly or fully. Occurrence of a RLF may lead to a loss of service(s), functionality(-ies) and/or the connection itself. A RLF may be caused, for example by a low signal strength, e.g. moving out of coverage area, high interference, e.g. due to other apparatuses, hardware failure, e.g. UE or network node, network congestion, e.g. leading to resources being unavailable and/or poor link quality, e.g. due to environmental factors such as obstacle(s) and/or weather, or the like.

Determining that a RLF “is about to occur” may be understood in determining, detecting and/or noticing that a radio link is deteriorating and is likely to or that will fail soon. This may be referred to as an upcoming RLF, an impending RLF, an imminent RLF, a forthcoming RLF, an approaching RLF, a potential RLF and/or a looming RLF (these terms may be used interchangeably herein). In other words, the link may deteriorate to a point where it can no longer support reliable communication. Determining that the RLF may be carried out by an apparatus, e.g. a UE and/or a network node. For example, the UE may monitor, observe, watch, measure, surveil and/or track the link, e.g. the radio link to determine and/or detect that an RLF is about to occur. In other words, the UE may detect an imminent RLF by, in particular continuously, monitoring at least one of: signal strength, quality, error rate(s), synchronization, and/or interference level(s). By identifying such warning signs early, the UE and/or the network node can take proactive measures to avoid a complete link/connection failure. There are multiple ways to do so. For example, the UE may, in particular continuously, monitor a quality of the radio link and/or radio signals. It may perform i) signal quality measurements, including measure a strength of at least one, in particular reference signal (Reference Singal Received Power, “RSRP”), which may be threshold based, e.g. if RSRP falls below a predefined threshold, the UE may consider the link to be in danger of failure. It may measure the signal quality relative to noise and/or interference (Reference Signal Received Quality, “RSRQ”), e.g. a, in particular sharp, drop in RSRQ may indicate worsening link conditions and an impending RLF. It may determine ii) Error Rates and/or Decoding Failures, including Block Error Rate (BLER), e.g. tracking a rate of errors in the data blocks received, which may be threshold-based, e.g. a high BLER may indicate that the link is becoming unreliable; HARQ (Hybrid Automatic Repeat Request) Retransmissions), e.g. the UE may monitors the number of retransmissions required to successfully decode data, wherein frequent and/or excessive retransmissions may suggest link degradation. It may determine iii) Timing Advance (TA) Drifts, e.g. large and/or frequent variations in the TA value may indicate issues with signal propagation and/or link quality, signaling a potential RLF. It may determine iv) Loss of Synchronization, e.g. as the UE may maintains synchronization with the base station for both uplink and/or downlink transmissions, it may declare an Out-of-Sync (OoS) condition, e.g. if it fails to decode critical references signals over, in particular consecutive, subframes. It may determine v) Physical Uplink Control Channel (PUCCH) Transmission Failures, e.g. failure to transmit acknowledgments, control information, and/or scheduling requests could indicate uplink instability. It may determine vi) Handover failures, e.g. if the UE cannot successfully hand over to a stronger neighboring cell when the signal deteriorates, it may face an imminent RLF. It may determine vii) Interference, e.g. the UE may detect increasing inter-cell and/or intra-cell interference levels, which can degrade signal quality and/or lead to RLF. In other words, the UE may monitor one or more parameter(s) as above and when these metrics cross, e.g. predefined thresholds, the UE may predict that the link is about to fail. The UE may also combine one or more of the aforementioned indicators i)-vii) to provide a more robust/reliable detection of an imminent RLF. Upon detecting that an RLF is imminent (i.e., the link is degrading and/or close to failure), the UE may take proactive action by initiating a request to prevent complete link loss and/or ensure robust connectivity as mentioned herein.

Examples mentioned herein may describe scenarios where either the UE detects an imminent RLF or where the network or network node detects an imminent RLF. Depending on the failure, the time may variate a lot, e.g. in some cases, the UE may detect it faster and, in some case, the network node may detect it faster. It should be noted that both examples, e.g. UE/network node detects, may also be combined herein.

A “network node” or base station may correspond to an apparatus or a, in particular functional, element in a mobile or cellular network responsible for managing radio communication with another apparatus, e.g. a UE, and/or handling Control Plane (CP) and/or User Plane (UP) operations/functionalities. In a non-limiting example of a fifth Generation (5G) network node may be referred to as gNodeB (gNB), which may include a Centralized Unit (CU), which may manage control plane signaling and/or higher-layer functions like Radio Resource Control (RRC), and a Distributed Unit (DU), which may may handle lower-layer functions and/or user plane data, e.g. closer to the radio interface. A network node may be divided into and/or comprise different, in particular serving, cells, in particular at least one first cell and at least one second cell. The first cell may be regarded as a, in particular currently, service cell and/or a main or primary service cell that, e.g. establishes and/or maintains the connection to the UE. In the non-limiting example of 5G, the at least one first cell may correspond to at least one Primary Cell (PCell), which may handle and/or be tied to CP related functionalities, such as initial connection setup, e.g. RRC protocol, handling signaling messages, mobility management (e.g. handovers) and/or radio resources management. The RRC layer of the PCell may be responsible for managing radio resources, including the configuration and/or activation of Spectrum Aggregation as mentioned herein and/or may ensure that the UE is aware of the available spectrum resources. The second cell may be regarded as an additional cell, e.g. in addition to the at least one first cell, e.g. to enhance connectivity and/or data throughput. The at least one second cell may be used for data transmissions. In the non-limiting example of 5G, the at least one second cell may correspond to at least one Secondary Cell (SCell) used for user plane data transmission, e.g. to increase throughput and/or capacity. It may be the case, that the at least one first cell is associated with a primary connection that may be activated first and/or it may be ensured that the at least one first cell is operational. Thereafter, at least one additional cells, e.g. the at least one second cell, may be added, e.g. on top of the at least one first cell and/or the primary connection, which may serve as a backup.

When the at least one first cell and the at least one second cell are included in the same network node, “spectrum aggregation” may be applied, which may enable aggregating traffic from different spectrum resources. This may be referred to as intra-node aggregation. It may allow the UE to transmit and/or receive, in particular combined, data over multiple spectrum resources, in particular simultaneously. Spectrum Aggregation may be regarded as a technique where multiple spectrum resources are combined to enhance the overall capacity, reliability, and/or speed of the connection between the UE and the network. Spectrum Aggregation may include i) Carrier Aggregation, which aggregates multiple carriers with the same or different frequency bands; ii) Dual Connectivity (DC), which may be referred to as inter-node aggregation. When the at least one first cell and the at least one second cell are included in different network nodes, e.g. two network nodes, “dual connectivity” may be applied, which may enable aggregating resources from different network nodes and which may allow the UE to maintain a simultaneous connection with two different network nodes or base stations, typically one serving as the Master Node (MN) and the other as the Secondary Node (SN); and/or iii) Bandwidth Parts (BWP), e.g. allowing dynamic switching between different bandwidth parts within the same carrier. Spectrum aggregation may provide increased data throughput, e.g. by using multiple carriers or bands simultaneously, improved reliability/robust connectivity, e.g. if one link degrades, another can maintain the connection and/or better resource utilization, e.g. it allows to efficiently use/share the available spectrum. A “spectrum resource” may be regarded as a part, element and/or chunk of, associated with and/or related to a radio frequency used for transmitting data, e.g. between the UE and a network. It may refer to and/or include at least one frequency band, at least one carrier and/or a bandwidth unit that can be allocated, assigned and/or activated.

At least one cell, e.g. at least one first cell and at least one second cell, as mentioned herein, may be a) active or in an active state or condition, or b) inactive or in an inactive state or condition. An active cell may be regarded as, in particular fully, operations and/or it may participate in CP and/or UP functions, operations and/or activities. An inactive cell may be regarded as a cell which is currently not in operation or configured, e.g. it may not, in particular actively, transmit and/or receive, e.g. data. It may be in a dormant or sleep state, be not configured yet and/or CP/UP activity is minimal or substantially non-existent in the inactive cell. A state/condition, e.g. active/inactive, of the at least one cell as mentioned herein may be changed and/or switched, e.g. it may be activated, inactivated and/or reactivated etc. A cell may become inactive when data demand is lower, e.g. to reduce power consumption on both the UE-side and/or the network node, when resources are allocated, e.g. to cells where there are most needed, e.g. optimizing spectrum usage and/or due to deteriorating signal quality and/or connection links.

The at least one cell, e.g. at least one first cell and at least one second cell, as mentioned herein, may be associated with at least one spectrum resource, e.g. at least one carrier. The at least one spectrum resource may be A) active or in an active state or condition, or B) inactive or in an inactive state or condition. Different spectrum resources may be active/inactive independently from each other. The at least one spectrum resource may be configured, designated, intended, set and/or specified for spectrum aggregation. Activation of the at least one spectrum resource may mean activation for spectrum aggregation. This may correspond to an on-demand activation, e.g. when traffic increases, more capacity is needed and/or when a RLF is imminent as mentioned herein. The at least one spectrum resource may thus be also referred to as a spectrum resource that is activatable or as a spectrum resource that is conditionally activatable. The same may also be pre-configured, e.g. by the network node. The conditionally activatable spectrum resources may be a spectrum resource that may be activated under a certain condition and/or on-demand as mentioned before, e.g. activated only when necessary, e.g. upon a trigger or trigger criterion. The conditionally activatable spectrum resource may be regarded as a dynamic spectrum resource, a backup spectrum resource and/or an auxiliary spectrum resource. Correspondingly, when the data demand decreases and/or the radio link threatened for RLF has recovered, the at least one spectrum resource may be deactivated again, e.g. to conserve resources while maintaining basic connectivity through the, e.g. the at least one first cell. In the non-limiting example of 5G and/or Carrier Aggregation as Spectrum Aggregation, conditionally activatable carrier(s) may be used for a Secondary Cell (SCells) and may remain dormant, e.g. until the Primary Cell (PCell) requires additional resources, e.g. in cases of imminent RLF. In Dual Connectivity, a conditionally activatable carrier may be associated with a Secondary Node (SN) and activated when the connection to the Master Node (MN) weakens or requires more capacity. A Bandwidth Part (BWP) may be configured as conditionally activatable, where it remains inactive, e.g. until a specific QoS requirement or network policy activates it.

“switching” to a radio link may be understood in changing to, moving to and/or jumping or navigating to another radio link that is different than the radio link currently in use. For example, switching may occur from the radio link associated with the at least one first cell, e.g. a first radio link which is currently used or serving the UE and/or for which it is determined that RLF is about to occur, to a radio link associated with the at least one second cell, e.g. another radio link or a second radio link. Switching to the radio link associated with the at least one second cell my occur without data flow interruption, e.g. uninterruptedly, continuously, smooth and/or may enable and/or allow a robust connection, e.g. such that the data flow is not, in particular negatively, affected. It may also be said that this is minimal data flow break. For example, if a carrier fails then, e.g. in the lower layer, there may be a break, but, e.g. in a higher layer like PDCP, it may be possible that this break is not visible.

The “indication” may be a flag or pointer which is, e.g. directly, included or encoded, e.g. in a message from the network node, for example, using one or mor bits. This indication may be an explicit indication, e.g. it may be read and/or directly causing an action, e.g. the switching. However, instead of an (explicit) indication, data/information for determining the indication may be provided. As such, the indication may be determined, e.g. from the data/information, e.g. within the message. In certain cases, “determining the indication” may be understood in i) accessing, reading and/or extracting the (explicit) indication from the message, e.g. directly; in which case it may also be referred to as “receiving an indication”, or ii) deriving, computing and/or inferring the indication from the data/information within the message, e.g. indirectly. As such, the indication may be referred to as an explicit indication, e.g. if it is readable, or as an implicit indication, e.g. if it is derivable. In case of an implicit indication, data or information for determining or deriving the indication may be provided, as mentioned above. Such data or information may be another information element to which the indication has been embedded. In such a case, the UE may first decode the information element and then derive the indication (and another indication) from the information element. It should be noted that it is not necessary to explicitly refer to “explicit/implicit” with respect to the indication(s), as this fact may simply follow from the terms alone, e.g. “indication” (e.g. explicit), or “data or information” to determine/derive the same, e.g. implicit. “data or information” for determining or deriving the indication may allow the UE to interpret and/or conclude to the indication, e.g. also by using bits. In some cases, the indication may occupy fewer bits as compared to using data or information. Also, data or information may, in some cases, require the UE to perform at least some processing, e.g. to determine/derive and/or conclude to the indication.

It should be noted that the indication as recited herein may correspond to “at least one indication” or the indication may correspond to a single indication having multiple parts. In other words, there may be a first indication and a second indication, or there may be a single indication having at least a first part indicating a first information, and a second part indicating a second information. With respect to the above, this could mean that the indication indicates, e.g. switching, using one (first) part and indicating, e.g. that activation of spectrum aggregation was successful, using another (second) part, or vice versa. Additional parts of the indication may be conceivable which may indicate other/further information. Alternatively, two indications may be used. “Based at least in part on the indication” may, for example, mean based on one or more part(s) of the indication. In other cases, it may mean, for example, based on the indication, e.g. as a whole, but also based on additional information and/or additional information element(s), parameters or data.

According to example, the at least one second cell has been configured or was/is configured to “take over for” the at least one first cell. This may be understood in that the at least one second cell assumes, takes and/or handles one or more responsibility (ies), operation(s) and/or function(s) of the at least one first cell. It may also be understood in that the at least one second cell has become a new at least one first cell, e.g. the at least one second cell has been configured to replace, step in for, substitute for and/or act as the new at least one first cell, e.g. in cases of imminent RLF of the at least one (old) first cell.

A “backup configuration” may include one or more, in particular pre-defined set of parameter(s), e.g. a Radio Resource Control (RRC) parameter, setting(s) and/or resource(s), that the apparatus, e.g. the UE may use, e.g. for switching, e.g. in cases of failure or degradation of a link, e.g. an imminent RLF. The at least one backup configuration of the at least one first cell may be available before detection that the RLF of the radio link associated with the at least one first cell is about to occur. This may be understood in that the backup configuration is already accessible to the UE, e.g. before it detects an imminent RLF. Having the backup configuration available beforehand may allow the UE to rapidly counteract a potential RLF without waiting for new instructions/message, e.g. from the network and/or may ensure robust connectivity. The at least one backup configuration of the at least one first cell may be stored or pre-stored in the apparatus, e.g. within the UE itself, rather than, e.g. being dynamically requested from the network at the moment of failure. Since the configuration is already stored, the UE can quickly switch to an alternate cell without waiting for network. The at least one backup configuration of the at least one first cell may be provided, e.g. by the network node, e.g. within a message, e.g. a RRC message, in particular using a radio link associated with the at least one first cell, e.g. before a RLF is about to occur. Using the at least one backup configuration may also guarantee that spectrum aggregation can provide robust connection for all spectrum resources. The at least one backup configuration of the at least one first cell may include data or information indicative of when spectrum resources, e.g. inactive spectrum resources and/or conditionally activatable spectrum resources, are activatable. When the UE detects an imminent RLF, it may have already at least one second cell at least partially (or fully) in use or alternatively it may have one or more second cell(s) configured, e.g. RRC configured, but not activated. In this kind of case, it may be unnecessary to do complete RRC reestablishment and configure the UE again. This would cause long data break and/or would not be able to provide, e.g. URLLC service. However, examples mentioned herein may allow to reuse the already provided backup configuration, e.g. to activate and/or configure any redundant cell(s) to be a new first cell, which may speed up configuration change(s), e.g. to configure the redundant cell to be an active cell.

The apparatus, e.g. the network node and/or the UE, may modify the at least one backup configuration, e.g. after switching from a failing connection (associated with at least one first cell) to a new connection (associated with at least one second cell). After switching, the backup configuration may be updated, altered changed, adjusted and/or amended, e.g. to take into account and/or reflect the changes after switching. For example, after the switch, the network node may send a message to the UE, instructing/triggering it to modify the backup configuration. Switching may be done according to rules, e.g. a backup configuration, as outlined herein. So, it may be possible that the radio link is (already) there but now, e.g. after switching, also some new services like voice start to use this link.

Detecting that the RLF is about to occur may initiate or trigger requesting activation according to example embodiments. This may mean that once the UE detects the imminent RLF, it may, in particular in response thereto and/or immediately, send a request, e.g. to the network node, to activate spectrum aggregation for at least one alternative or conditionally activatable spectrum resource. This may allow the UE to decide when spectrum aggregation is to be activated. This may allow the UE to be less dependent on the network node and/or may avoid additional messages triggering the UE which may minimize signaling overhead.

The apparatus may be informed beforehand which of the at least one spectrum resource(s) may be designated, configured, available and/or intended for spectrum aggregation. This may be achieved by an indication as mentioned herein. For example, the UE may receive an indication, e.g. a first indication, e.g. from the at least one first cell, before detecting that the RLF is about to occur, which indicates that the at least one spectrum resource is designated for spectrum aggregation. Thereafter, e.g. when an imminent RLF is detected, the UE may receive another indication, e.g. a second indication for switching. However, the first indication may be optional.

Requesting activation may be understood in, e.g., transmitting an activation request. The activation request may be a message, e.g. sent by the UE to the at least one second cell, e.g. to activate spectrum aggregation for at least one spectrum resource. However, the activation request may also be at least one indication. The at least one second cell may either be (already) active or inactive.

When the at least one second cell is active, the activation request may be transmitted via Uplink Control Information (UCI), e.g. to the at least one active second cell. Uplink Control Information (UCI) may be understood as a signaling mechanism, e.g. used by the UE, to transmit for example control messages to the network node, e.g. in the uplink (UL) direction. In other words, the activation request may be transmitted using UCI e.g. over existing uplink control channels. UCI may allow for fast transmission of control-plane information, e.g. avoiding a need to set up a new connection to the at least one second cell. UCI may also be regarded as lightweight and/or transmitted frequently, which may lead to low-latency requests such as activation of additional spectrum resources.

The apparatus, e.g. the UE, may assign at least one broadcasting resource to the at least one active second cell, for example using at least one backup configuration of the at least one first cell. The at least one broadcasting resource may be at least one system resource which may include for example at least one channel, signal and/or frequency. For example, the at least one broadcasting resource may carry Uplink Control Information (UCI). The at least one broadcasting resource may be a Physical Uplink Control Channel (PUCCH) or a Physical Uplink Shared Channel (PUSCH). PUSCH may be regarded as a shared, e.g. uplink, channel primarily used for transmitting user-plane data but can also carry control-plane signaling. By leveraging the already active PUSCH, additional signaling (e.g., spectrum aggregation requests) may not require separate channels, reducing resource overhead. PUCCH may be a dedicated, e.g. uplink, channel used e.g. for transmitting control-plane information like UCI. PUCCH may allow the active cell to manage uplink resources more efficiently, e.g. reserving other channels for user data.

Transmitting an activation request and/or using/assigning at least one broadcasting resource such as UCI via PUCCH or PUSCH may provide an efficient and/or reliable approach to enable seamless communication, robust connectivity, dynamic optimization, and/or real-time responses to changing network conditions, ensuring robust and/or efficient utilization of the radio link. Since the cell is already active, there may be no need for connection re-establishment, enabling fast and/or near-instantaneous transmission, e.g. of control information. Leveraging existing channels (UCI via PUCCH or PUSCH) may avoid the need for additional setup, saving spectrum and/or computational resources, both on the network-node side and/or the UE-side. UCI on PUCCH or PUSCH may allow the UE to request activation of spectrum resources without interrupting ongoing communication, ensuring smooth performance enhancements. The active cell can respond quickly to requests (e.g., activating backup configurations or enabling additional carriers) to maintain connection robustness during degradation.

The at least one broadcasting resource may be a broadcasting resource for cell activation, e.g. when the at least one second cell is inactive. The apparatus, e.g. the UE, may assign at least one broadcasting resource for cel activation to the at least one active second cell, e.g. using the at least one backup configuration of the at least one first cell. The at least one broadcasting resource for cell activation may include at least one of i) a cell activation preamble, e.g. a signaling sequence transmitted, e.g. by the UE to indicate its intention to activate the secondary cell (SCell), which may serve as a handshake to initiate communication with the inactive cell, ii) a Random Access Channel (RACH), an e.g. uplink channel used, e.g. by the UE, to request resources and/or establish a connection with the network node, which may facilitate the activation of the inactive second cell, and/or iii) an Uplink (UL) grant, e.g. a permission or permission signal that allocates uplink resources. For example, after receiving the UL grant, the UE can use these resources to transmit further activation-related signaling or data.

When the at least one second cell is inactive, the UE may use a broadcasting resource to signal its activation. These resources include cell activation preambles, RACH, and UL grants, which may enable efficient and/or reliable activation. By leveraging the backup configuration of the first cell, it may be ensured that the second cell can be integrated into the communication flow without causing additional signaling overhead. For example, by using predefined broadcasting resources (e.g., RACH), it may be ensured that the second cell can be quickly activated without requiring extensive signaling. Also, leveraging stored configurations from the first cell may simplify the process of activating the second cell.

A Logical Channel Identifier (LCID) may be a field, indication, identifier or indicator, e.g. in a protocol, that identifies specific logical channels, e.g. for transmitting data and/or control information. A conditional LCID may refer to an identifier that may become operational or active under certain circumstances or conditions. It may be the case that when a conditional spectrum resource is activated, a corresponding LCID becomes active. If a cell is not active, LCID may remain dormant. The activation of a conditional spectrum resource may occur first (e.g., activating an Cell or carrier). Afterwards, the logical channel(s) (LCIDs) tied to these resources may become active, e.g. enabling the transfer of specific data or signaling. LCIDs may be used for mapping and/or managing data flow on spectrum resource(s).

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The apparatus may include a processor configured to provide signals to and receive signals and to control the functioning of the apparatus. The processor may be configured to control other elements of apparatus by effecting control signaling via electrical leads connecting processor to the other elements, such as a display or a memory. The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof.

The term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
hardware circuit(s) and/or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The apparatus may comprise memory which may store information elements. The apparatus may include volatile memory and/or non-volatile memory. For example, volatile memory may include Random Access Memory (RAM) including dynamic and/or static RAM, on-chip or off-chip cache memory, and/or the like. Non-volatile memory, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory, non-volatile memory may include a cache area for temporary storage of data. At least part of the volatile and/or non-volatile memory may be embedded in processor. The memories may store one or more software programs, instructions, pieces of information, data, and/or the like which may be used by the apparatus for performing operations disclosed herein.

In examples, the apparatus may be a UE or may be at least comprised in a UE. In examples, the apparatus may be a network node or may be at least comprised in a network node.

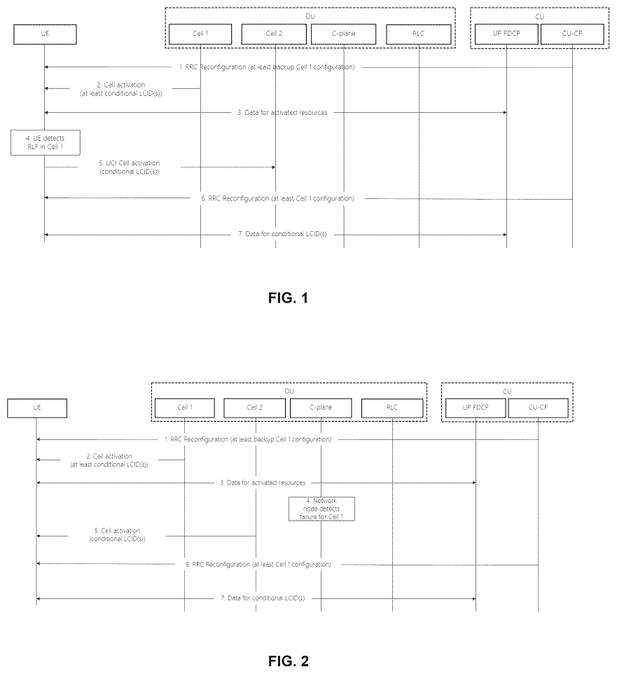

FIG. 1 shows an example signaling chart according to examples described herein. The example of FIG. 1 may correspond to a case where the at least one second cell (Cell 2) is (already) active and/or where the UE may detect (cf. step 4) that a Radio Link Failure (RLF) of a radio link associated with at least one first cell (Cell 1) is about to occur.

FIG. 1 may be explained by the following, non-limiting steps:

In step 1, the UE may receive at least one message, e.g. a first message such as, for example, a Radio Resource Control Reconfiguration message, which includes at least one backup Cell 1 configuration. The UE may determine, retrieve and/or determine this backup configuration from the message. The backup Cell 1 configuration may include an RRC parameter, e.g. to modify the at least one second cell to take over for/act as the at least one (new) first cell; an (additional) Physical Uplink Control Channel (PUCCH) resource, an (additional) Physical Uplink Shared Channel (PUSCH) resource, a rule when, e.g. the UE, can activate the at least one, e.g. conditionally activated, second cell. The backup Cell 1 configuration may include or be indicative of at least one spectrum resource that is designated, configured for spectrum aggregation, e.g. conditionally activatable. The backup Cell 1 configuration may be stored or pre-stored in the UE, e.g. for imminent RLF(s), e.g. as a backup. The first message may optionally also comprise a spectrum aggregation, e.g. a Carriere Aggregation (CA), configuration, e.g. in addition to the backup Cell 1 configuration.

In step 2, which may be optional, the network node, e.g. Cell 1, may transmit at least one indication, e.g. a first indication. The indication may indicate at least one spectrum resource, e.g. at least one carrier, that is designated for spectrum aggregation and/or at least conditional LCID(s). For example, the indication may indicate at least one spectrum resource that is conditionally activatable, e.g. in cases of failure. In this step, it may be possible that the network node activates spectrum aggregation for at least some spectrum resources. The indication may include or be indicative of at least the at least one spectrum resource that is conditionally activatable. The indication may also include or be indicative of one or more (already) activated/active spectrum resource(s).

In step 3, data, in particular for activated spectrum resources, may be exchanged between the UE and the network node. This step may also be optional.

In step 4, the UE may detect that a Radio Link Failure (RLF) of a radio link associated with at least one first cell (Cell 1) is about to occur. Instead of triggering RLF and/or a re-establishment procedure, in particular a Radio Resource Control (RRC) re-establishment procedure, the UE may request activation, e.g. by transmitting a message (s. step 5), for example an activation request, of at least one spectrum resource that is associated with at least one second cell configured for spectrum aggregation. Skipping of the re-establishment procedure may be initiated by the indication from the network node. This may be encoded, in particular at least partly, in the indication. In other examples, the UE may decide skipping the re-establishment procedure by itself, e.g. based on detection of the imminent RLF. In this step, the UE may request activation of the at least one spectrum resource for the backup Cell 1 spectrum resource, e.g. of/using the backup Cell 1 configuration.

In step 5, the UE may transmit, based at least in part on detection that a Radio Link Failure (RLF) of a radio link associated with at least one first cell is about to occur, a message to the network node. The message may be or include an activation request, which may include spectrum aggregation activation for at least one spectrum resource. As mentioned, in FIG. 1, the at least one second cell (Cell 2) is already active. As such, the activation request may be transmitted via Uplink Control Information (UCI) to the at least one second cell (Cell 2). This step may include assigning at least one broadcasting resource to the at least one active second cell. For assigning the at least one broadcasting resource, the at least one backup configuration of the at least one first cell (s. step 1) may be used. The at least one broadcasting resource may carry Uplink Control Information (UCI). The at least one broadcasting resource may be a Physical Uplink Control Channel (PUCCH) or a Physical Uplink Shared Channel (PUSCH).

In step 6, which may be optional, the UE may receive a message, e.g. a second message such as, for example, a Radio Resource Control Reconfiguration message. Alternatively, and or in addition, the UE may receive another/a further indication, e.g. a second indication, that indicates i) that spectrum aggregation activation, e.g. for the at least one spectrum resource, was successful and/or ii) that the at least one active second cell has been configured to take over for the at least one first cell. The, e.g. second, message may initiate modification of the at the at least one backup configuration, in particular after switching to the radio link associated with the at least one active second cell. This step may not cause re-sync or data loss as the UE may already have a connection for the at least one second cell.

In step 7, which may be optional, data may be exchanged between the UE and the network node. In particular, the UE may transmit (and/or receive) data (to the at least one second cell/from the at least one second cell) using the at least one spectrum resource after switching to the radio link associated with the at least one active second cell.

FIG. 2 shows an example signaling chart according to examples described herein. The example of FIG. 2 may correspond to a case where the at least one second cell (Cell 2) is (already) active and/or where the network node may detect (cf. step 4) that a Radio Link Failure (RLF) of a radio link associated with at least one first cell (Cell 1) is about to occur. Steps 1-3 may correspond to the steps discussed with respect to FIG. 1, e.g. only from the perspective of the network-node-side.

FIG. 2 may be explained by the following, non-limiting steps:

In step 4, the network node may detect that a Radio Link Failure (RLF) of a radio link associated with at least one first cell (Cell 1) is about to occur. The network node may activate, based at least in part on detection that a Radio Link Failure (RLF) of a radio link associated with at least one first cell is about to occur, at least one spectrum resource that is associated with at least one second cell configured for spectrum aggregation.

In step 5, the network node may transmit, based at least in part on detection that a Radio Link Failure (RLF) of a radio link associated with at least one first cell is about to occur, an indication that indicates activation of the at least one spectrum resource and/or at least conditional LCID(s) that is associated with at least one second cell configured for spectrum aggregation. The indication may also indicate that the at least one second cell is or has been (already) active. The indication may also be included in a message. The indication may indicate that a radio link associated with the at least one second cell is available for radio link switching and/or that spectrum aggregation activation was successful. As mentioned, in FIG. 1, the at least one second cell (Cell 2) is already active. The indication may be transmitted via at least one of a lower layer signal and/or UCI.

In step 6, the network node may transmit a message, such as, for example, a Radio Resource Control Reconfiguration message. The message may initiate modification of the at the at least one backup configuration, in particular after switching to the radio link associated with the at least one active second cell. The message may include an indication that the at least one second cell has taken over for the at least one first cell. An indication may also be sufficient, since the UE may already have a connection to the at least one active second cell.

In step 7, which may be optional, data may be exchanged between the UE and the network node. In particular, the network node may transmit (and/or receive) data using the at least one spectrum resource after switching to the radio link associated with the at least one active second cell.

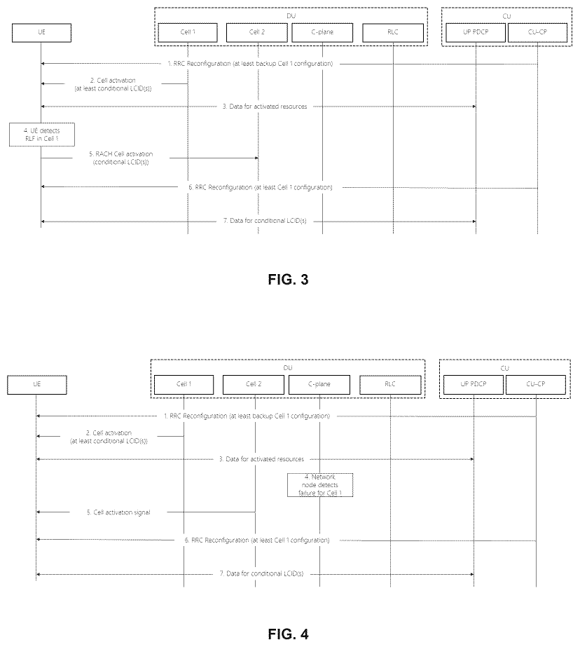

FIG. 3 shows an example signaling chart according to examples described herein. The example of FIG. 3 may correspond to a case where the at least one second cell (Cell 2) is inactive and/or where the UE may detect (cf. step 4) that a Radio Link Failure (RLF) of a radio link associated with at least one first cell (Cell 1) is about to occur.

FIG. 3 may be explained by the following, non-limiting steps:

In step 1, the UE may receive at least one message, e.g. a first message such as, for example, a Radio Resource Control Reconfiguration message, which includes at least one backup Cell 1 configuration. The UE may determine and/or retrieve or determine this backup configuration from the message. The backup Cell 1 configuration may include an RRC parameter, e.g. to modify the at least one second cell to take over for/act as the at least one (new) first cell; an (additional) Physical Uplink Control Channel (PUCCH) resource, an (additional) Physical Shared Control Channel (PUSCH) resource, a rule when, e.g. the UE, can activate the at least one, e.g. conditionally activated, second cell, and/or a resource for cell activation, including at least one of: a cell activation preamble, Random Access Channel (RACH) and/or Uplink (UL) grant and/or a carrier preference for the at least one second cell. The backup Cell 1 configuration may include or be indicative of at least one spectrum resource that is designated, configured for spectrum aggregation, e.g. conditionally activatable. The backup Cell 1 configuration may be stored or pre-stored in the UE, e.g. for imminent RLF(s), e.g. as a backup. The first message may optionally also comprise a spectrum aggregation, e.g. a Carriere Aggregation (CA), configuration, e.g. in addition to the backup Cell 1 configuration.

In step 2, which may be optional, the network node, e.g. Cell 1, may transmit at least one indication, e.g. a first indication. The indication may indicate at least one spectrum resource, e.g. at least one carrier, that is designated for spectrum aggregation, and/or at least conditional LCID(s). For example, the indication may indicate at least one spectrum resource that is conditionally activatable, e.g. in cases of failure. In this step, it may be possible that the network node activates spectrum aggregation for at least some spectrum resources. The indication may include or be indicative of at least the at least one spectrum resource that is conditionally activatable. The indication may also include or be indicative of one or more (already) activated/active spectrum resource(s).

In step 3, data, in particular for activated spectrum resources, may be exchanged between the UE and the network node. This step may also be optional.

In step 4, the UE may detect that a Radio Link Failure (RLF) of a radio link associated with at least one first cell (Cell 1) is about to occur. Instead of triggering RLF and/or a re-establishment procedure, in particular a Radio Resource Control (RRC) re-establishment procedure, the UE may request activation, e.g. by transmitting a message (s. step 5), for example an activation request, of at least one spectrum resource that is associated with at least one second cell configured for spectrum aggregation. Skipping of the re-establishment procedure may be initiated by the indication from the network node. This may be encoded, in particular at least partly, in the indication. In other examples, the UE may decide skipping the re-establishment procedure by itself, e.g. based on detection of the imminent RLF. In this step, the UE may request activation of the at least one spectrum resource for the needed spectrum resources, e.g. of/using the backup Cell 1 configuration.

In step 5, the UE may transmit, based at least in part on detection that a Radio Link Failure (RLF) of a radio link associated with at least one first cell is about to occur, a message to the network node. The message may be or include an activation request, which may include spectrum aggregation activation for at least one spectrum resource. As mentioned, in FIG. 3, the at least one second cell (Cell 2) is inactive. As such, the activation request may be transmitted via predefined resources, e.g. at least one broadcasting resource in the backup Cell 1 configuration to the at least one second cell (Cell 2). This step may include assigning at least one broadcasting resource for cell activation to the at least one inactive second cell. For assigning the at least one broadcasting resource for cell activation, the at least one backup configuration of the at least one first cell (s. step 1) may be used. The at least one broadcasting resource for cell activation may include at least one of: a cell activation preamble, a Random Access Channel (RACH) and/or an Uplink (UL) grant. The at least one broadcasting resource may be a Physical Uplink Control Channel (PUCCH) or a Physical Uplink Shared Channel (PUSCH).

In step 6, which may be optional, the UE may receive a message, e.g. a second message such as, for example, a Radio Resource Control Reconfiguration message. Alternatively, and or in addition, the UE may receive another/a further indication, e.g. a second indication, that indicates i) that spectrum aggregation activation, e.g. for the at least one spectrum resource, was successful and/or ii) that the at least one active second cell has been configured to take over for the at least one first cell. The, e.g. second, message may initiate modification of the at the at least one backup configuration, in particular after switching to the radio link associated with the at least one active second cell. This step may not cause re-sync or data loss as the UE may already have a connection for the at least one second cell.

In step 7, which may be optional, data may be exchanged between the UE and the network node. In particular, the UE may transmit (and/or receive) data (to the at least on second cell/from the at least one second cell) using the at least one spectrum resource after switching to the radio link associated with the at least one active second cell.

FIG. 4 shows an example signaling chart according to examples described herein. The example of FIG. 4 may correspond to a case where the at least one second cell (Cell 2) is inactive and/or where the network node may detect (cf. step 4) that a Radio Link Failure (RLF) of a radio link associated with at least one first cell (Cell 1) is about to occur. Steps 1-3 may correspond to the steps discussed with respect to FIG. 3, e.g. only from the perspective of the network-node-side.

FIG. 4 may be explained by the following, non-limiting steps:

In step 4, the network node may detect that a Radio Link Failure (RLF) of a radio link associated with at least one first cell (Cell 1) is about to occur. The network node may activate, based at least in part on detection that a Radio Link Failure (RLF) of a radio link associated with at least one first cell is about to occur, at least one spectrum resource that is associated with at least one second cell configured for spectrum aggregation.

The network node may activate the at least one second inactive cell to take over for the at least one first cell, e.g. to be the or act as the new first cell. In step 5, the network node may transmit, based at least in part on detection that a Radio Link Failure (RLF) of a radio link associated with at least one first cell is about to occur, an indication that indicates activation of the at least one spectrum resource that is associated with at least one second cell configured for spectrum aggregation and/or at least conditional LCID(s). The indication may also be included in a message. The indication may indicate that a radio link associated with the at least one second cell is available for radio link switching and/or that spectrum aggregation activation was successful. As mentioned, in FIG. 3, the at least one second cell (Cell 2) is inactive. The indication may be transmitted via at least one of a lower layer signal, a Wake Up Signal (WUS)-type of signal. The network node may deactivate the at least one first cell, wherein in particular the at least one first cell is deactivated based on activation of the at least one second inactive cell. However, the network node may maintain or keep the configuration associated with the at least one first cell, in particular based on deactivation of the at least one first cell, e.g. in cases of temporary failure and/or restore the at least one first cell using on the maintained configuration associated with the at least one first cell, based on detection that the radio link associated with the at least one first cell has recovered.

In step 6, the network node may transmit a message, such as, for example, a Radio Resource Control Reconfiguration message. The message may initiate modification of the at the at least one backup configuration, in particular after switching to the radio link associated with the at least one active second cell. The message may include an indication that the at least one second cell has taken over for the at least one first cell. An indication may also be sufficient, since the UE may already have a connection to the at least one active second cell.

In step 7, which may be optional, data may be exchanged between the UE and the network node. In particular, the network node may transmit (and/or receive) data using the at least one spectrum resource after switching to the radio link associated with the at least one second cell.

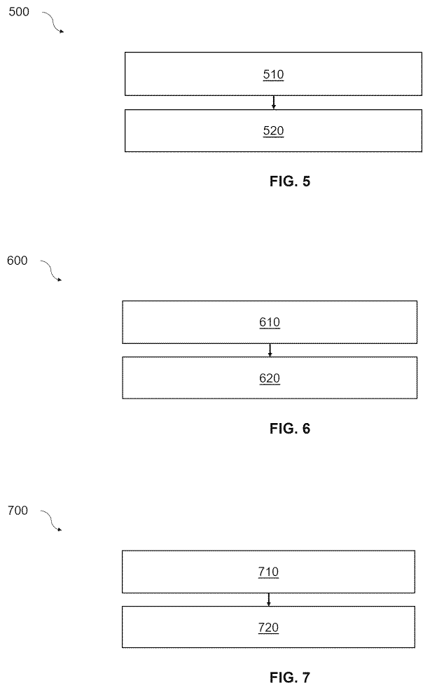

FIG. 5 shows a flow chart 500 of an example of subject-matter described herein. The flow chart may comprise steps of an apparatus, a method and/or a non-transitory computer readable medium as mentioned herein.

The flow chart 500 may include the step of requesting 510, based at least in part on detection that a Radio Link Failure (RLF) of a radio link associated with at least one first cell is about to occur, activation of at least one spectrum resource that is associated with at least one second cell configured for spectrum aggregation using at least one backup configuration of the at least one first cell. The flow chart may include the step of switching 520, based at least in part on an indication from a network node, to a radio link associated with the at least one second cell.

The flow chart 500 may comprise or be combined with one or more additional steps associated with some of the examples and/or associate example embodiments described herein.

FIG. 6 shows a flow chart 600 of an example of subject-matter described herein. The flow chart may comprise steps of an apparatus, a method and/or a non-transitory computer readable medium as mentioned herein.

The flow chart 600 may include the step of transmitting 610, based at least in part on detection that a Radio Link Failure (RLF) of a radio link associated with at least one first cell is about to occur, an activation request to at least one second cell which is active, wherein the activation request includes spectrum aggregation activation for at least one spectrum resource. The flow chart may include the step of switching 620, based at least in part on an indication from a network node, to a radio link associated with the at least one active second cell.

The flow chart 600 may comprise or be combined with one or more additional steps associated with some of the examples and/or associate example embodiments described herein.

FIG. 7 shows a flow chart 700 of an example of subject-matter described herein. The flow chart may comprise steps of an apparatus, a method and/or a non-transitory computer readable medium as mentioned herein.

The flow chart 700 may include the step of transmitting 710, based at least in part on detection that a Radio Link Failure (RLF) of a radio link associated with at least one first cell about to occur, an activation request to at least one second cell which is inactive, wherein the activation request includes spectrum aggregation activation for at least one spectrum resource. The flow chart may include the step of switching 720, based at least in part on an indication from a network node, to a radio link associated at least one inactive second cell.

The flow chart 700 may comprise or be combined with one or more additional steps associated with some of the examples and/or associate example embodiments described herein.

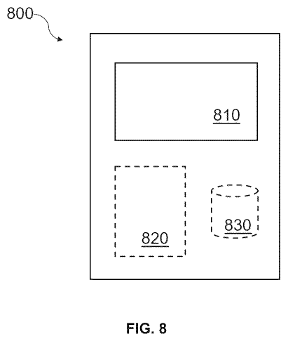

FIG. 8 shows an example apparatus 800, for example a User Equipment (UE). The apparatus 800 may include at least one processor 820 or at least one processing unit configured to provide signals and/or to receive signals and/or to control the functioning of the apparatus 800. The processor 820 may be configured to control other elements of apparatus 800, e.g. by effecting control signaling via electrical leads connecting processor to the other elements, such as a display 810 (only indicated in FIG. 8) or at least one memory 830. Needless to say that other/additional components may be included in the apparatus 800, e.g. for use in software and/or hardware aided execution of tasks it is designed to perform. Also, the apparatus 800 may receive signals and transmit signals, e.g. over an interface (not shown) and/or an antenna arrangement, e.g. internally or externally arranged in/on the apparatus 800. The processor 820 and/or memory 830 may be provided on a circuit board. Other components such as appropriate connectors (e.g. wired and/or wireless), user interfaces, such as a keyboard, touch sensitive element(s) and/or combinations thereof may be provided.

While the foregoing is directed to embodiments of the disclosure, other and further embodiments of the disclosure may be devised without departing from the basic scope thereof, and the scope thereof is determined by the claims that follow.

LIST OF ABBREVIATIONS

| | |
|---|---|
| 3GPP | 3rd Generation Partnership Project |
| BW | Bandwidth |
| CA | Carrier Aggregation |
| CC | Component Carrier |
| CE | Control Element |
| CG | Cell Group |
| CP | Control Plane |
| CSI | Channel State Information |
| CU | Central Unit |
| DL | Downlink |
| DRB | Data Radio Bearer |
| DRX | Discontinuous Reception |
| DU | Distributed Unit |
| gNB | 5G Node-B |
| HARQ | Hybrid Automatic Repeat request |
| HO | Handover |
| LCID | Logical Channel ID |
| MAC | Medium Access Control |
| MCG | Master Cell Group |
| NR | New Radio |
| PCell | Primary Cell |
| PDU | Protocol Data Unit |
| PUCCH | Physical Uplink Control Channel |
| RACH | Random Access Channel |
| RAN | Radio Access Network |
| RLC | Radio Link Control |
| RLF | Radio Link Failure |
| RRC | Radio Resource Control |
| SCell | Secondary Cell |
| SR | Scheduling Request |
| SRB | Signaling Radio Bearer |
| TCI | Transmission Configuration Indicator |
| UE | User Equipment |
| UL | Uplink |
| URLLC | Ultra Low Latency |
| UP | User Plane |
| WUS | Wake Up Signal |

LIST OF REFERENCE NUMERALS

| | |
|---|---|
| 800 | Apparatus |
| 810 | Display |
| 820 | Processor |
| 830 | Memory |

1.-40. (canceled)

41. Apparatus, comprising:
at least one processor; and
at least one memory storing instructions that, when executed by the at least one processor, cause the apparatus to:
receive, from a network node via a first cell, a radio resource control (RRC) reconfiguration message including a pre-stored backup configuration associated with the first cell, the backup configuration specifying:
(i) at least one conditionally activatable spectrum resource associated with a second cell, and
(ii) at least one broadcasting resource for cell activation comprising a random access channel (RACH) resource and a cell activation preamble;
store the backup configuration prior to occurrence of a radio link failure;
detect that a radio link failure (RLF) of a radio link associated with the first cell is imminent based on at least one of: reference signal received power, reference signal received quality, or block error rate exceeding a threshold;
based on the detection, and without initiating a radio resource control (RRC) re-establishment procedure, transmit an activation request to the second cell, the second cell being inactive, by transmitting, using the broadcasting resource defined in the backup configuration, at least one of the cell activation preamble and a RACH transmission, wherein the activation request requests activation of the at least one conditionally activatable spectrum resource for spectrum aggregation;
receive an indication from the network node that the at least one spectrum resource is activated and that the second cell is configured to take over for the first cell; and
switch, based on the indication, to a radio link associated with the second cell such that the second cell operates as a new primary cell for control plane communication, including activation of at least one logical channel identifier associated with the activated spectrum resource.

42. The apparatus of claim 41, wherein the backup configuration further specifies a rule defining when the at least one conditionally activatable spectrum resource is activatable based on detection of the imminent radio link failure.

43. The apparatus of claim 42, wherein the backup configuration further comprises at least one physical uplink control channel (PUCCH) resource and at least one physical uplink shared channel (PUSCH) resource associated with the second cell.

44. The apparatus of claim 43, wherein detecting that the radio link failure is imminent comprises detecting an out-of-synchronization condition based on failure to decode one or more reference signals over consecutive subframes.

45. The apparatus of claim 44, wherein the activation request further comprises uplink control information (UCI) transmitted using the broadcasting resource.

46. The apparatus of claim 45, wherein transmitting the activation request further comprises:
receiving, in response to the RACH transmission, an uplink grant, and
transmitting additional activation signaling using the uplink grant.

47. The apparatus of claim 46, wherein the indication received from the network node is transmitted via at least one of:
(i) a lower-layer signal, or
(ii) a wake-up signal (WUS).

48. The apparatus of claim 47, wherein switching to the radio link associated with the second cell is performed without interruption of user-plane data at a packet data convergence protocol (PDCP) layer.

49. The apparatus of claim 48, wherein the second cell, after switching, is configured to replace the first cell as a primary cell responsible for radio resource control signaling and mobility management.

50. The apparatus of claim 49, wherein the instructions further cause the apparatus to:
receive a subsequent radio resource control (RRC) message from the network node; and
modify the backup configuration based on the subsequent message after switching to the second cell.

51. A method performed by an apparatus, the method comprising:
receiving, from a network node via a first cell, a radio resource control (RRC) reconfiguration message including a pre-stored backup configuration associated with the first cell, the backup configuration specifying:
(i) at least one conditionally activatable spectrum resource associated with a second cell, and
(ii) at least one broadcasting resource for cell activation comprising a random access channel (RACH) resource and a cell activation preamble;
storing the backup configuration prior to occurrence of a radio link failure;
detecting that a radio link failure (RLF) of a radio link associated with the first cell is imminent based on at least one of: reference signal received power, reference signal received quality, or block error rate exceeding a threshold;
based on the detection, and without initiating a radio resource control (RRC) re-establishment procedure, transmitting an activation request to the second cell, the second cell being inactive, by transmitting, using the broadcasting resource defined in the backup configuration, at least one of the cell activation preamble and a RACH transmission, wherein the activation request requests activation of the at least one conditionally activatable spectrum resource for spectrum aggregation;
receiving an indication from the network node that the at least one spectrum resource is activated and that the second cell is configured to take over for the first cell; and
switching, based on the indication, to a radio link associated with the second cell such that the second cell operates as a new primary cell for control plane communication, including activation of at least one logical channel identifier associated with the activated spectrum resource.

52. The method of claim 51, wherein the backup configuration further specifies a rule defining when the at least one conditionally activatable spectrum resource is activatable based on detection of the imminent radio link failure.

53. The method of claim 52, wherein the backup configuration further comprises at least one physical uplink control channel (PUCCH) resource and at least one physical uplink shared channel (PUSCH) resource associated with the second cell.

54. The method of claim 53, wherein detecting that the radio link failure is imminent comprises detecting an out-of-synchronization condition based on failure to decode one or more reference signals over consecutive subframes.

55. The method of claim 54, wherein the activation request further comprises uplink control information (UCI) transmitted using the broadcasting resource.

56. The method of claim 55, wherein transmitting the activation request further comprises:
receiving, in response to the RACH transmission, an uplink grant, and
transmitting additional activation signaling using the uplink grant.

57. The method of claim 56, wherein the indication received from the network node is transmitted via at least one of:
(i) a lower-layer signal, or
(ii) a wake-up signal (WUS).

58. The method of claim 57, wherein switching to the radio link associated with the second cell is performed without interruption of user-plane data at a packet data convergence protocol (PDCP) layer.

59. The method of claim 58, wherein the second cell, after switching, is configured to replace the first cell as a primary cell responsible for radio resource control signaling and mobility management.

60. The method of claim 59, wherein the instructions further cause the apparatus to:
receive a subsequent radio resource control (RRC) message from the network node; and
modify the backup configuration based on the subsequent message after switching to the second cell.
